(19) United States
(12) Patent Application Publication
(10) Pub. No.: US 2023/0171116 A1
(43) Pub. Date: Jun. 1, 2023

(54) System and Method for Certified Digitization of Physical Objects

(71) Applicant: Microscopic Image Recognition Algorithms Inc., Durham, NC (US)

(72) Inventor: Ron Appel, Durham, NC (US)

(21) Appl. No.: 18/073,165

(22) Filed: Dec. 1, 2022

Related U.S. Application Data
(60) Provisional application No. 63/284,641, filed on Dec. 1, 2021.

(51) Int. Cl. H04L 9/32; H04L 9/00

(52) U.S. Cl. CPC H04L 9/3297; H04L 9/3236; H04L 9/50; H04L 9/3247

(57) ABSTRACT

Block header hashes of a blockchain are used as tokens for time stamps. Since the blockchain is ubiquitous with the block header hashes randomly generated and are practically immutable, the time stamps using the block header hashes are secure. A time stamping system uses a block header hash as a time stamp can be used to time stamp digitalized representation of a physical object. The time stamped digitalized representation of a physical object can be used as proof of current ownership of the physical object if the time stamp is adequately recent.

The present patent application claims priority from the U.S. Provisional Patent Application, Ser. No. 63/284,641, filed on Dec. 1, 2021, entitled “System and Method for Certified Digitization of Physical Objects”, of the same inventors, hereby incorporated by reference in its entirety.

The present patent application relates to U.S. patent application Ser. No. 17/623,423, filed on Mar. 19, 2022, entitled “Optical acquisition system and probing method for object matching”, of the same inventors, hereby incorporated by reference in its entirety.

### BACKGROUND OF THE INVENTION

The accurate re-identification of physical assets, such as valuable objects such as artwork, sculptures, or collectible items, is essential in properly tracking transactions and ensuring that ownership is certified for the unique valuable object as opposed to a forgery. The high-value-art market is already a multi-billion-dollar industry, and is only increasing with time. As a result, sophisticated forgeries are becoming more prominent and harder to distinguish from the genuine artwork.

Several methods have been proposed to re-identify objects. One class of methods requires the addition of physical tags (e.g. RFID chips or bar codes), but these modify and thereby devalue priceless objects, and further, can be removed and replaced. A more relevant class of methods uses digital registration of an object (e.g. via a scan), and at a later time, re-scans the object in question to verify whether or not it is the same as the original.

U.S. Pat. No. 10,019,646 describes a method for imaging an object, extracting features for identification, and comparing against a database of known (i.e. previous scans of) objects. U.S. Pat. No. 10,614,302 describes a method for automatically identifying regions of interest in the image resulting from the scan of an object, from which particular features are extracted and used in matching. U.S. Pat. No. 10,740,767 describes a method for the digital registration and matching of an object, using a decentralized storage system to store and access the registry. U.S. patent application Ser. No. 17/623,423 describes a method for scanning an object, comparing against a database of previous scans, and iteratively selecting more and more precise regions to scan in order to achieve very high match confidences efficiently. US20180253738A1 describes a method for matching of an object and its owner as a pair. However, with all known prior methods, a bad actor can obtain a copy of a previous scan (of arbitrarily high precision), and just inject the results (electronically or even optically) as if they had been newly acquired, thereby entirely sidestepping the certification and thus able to claim that they are currently in physical possession of the genuine item.

U.S. Pat. No. 8,455,990B2 and U.S. Pat. No. 7,472,836B2 describe systems that facilitate the tamper-proofing of semiconductor devices. While aspects of these prior art abate the ability for a bad actor to electronically inject results into the processing pipeline, they do not provide methods enabling specific types of radiation to reach appropriate sensors within the tamper-proof casing, which the current invention both proposes and requires.

However, nothing currently stops a bad actor from counterfeiting the digitized version of a valuable object (which may even have initially been genuinely authenticated) and presenting it at a later time, even though they no longer have access to the original object in question.

The current invention aims to solve this problem, ensuring that the digitization of a physical object may be genuinely certified only if that object is physically present at the current time and at a place of digitization.

### SUMMARY OF THE EMBODIMENTS

In some embodiments, the present invention discloses a system to digitally certify an object, and to ensure that such certified digitization can only occur if the object is physically present at the time and place of digitization. This is achieved through the combination of proof-of-time (leveraging a randomly generated but immutable sequence), and proof-of-presence (leveraging tamper-proof processing components combined with secure digital signatures).

In some embodiments, the present invention discloses systems and methods for time stamping with low cost and simplicity. The time stamping process utilizes a data stream that is synchronized ubiquitous around the world, e.g., the data stream can be found at any location having access to the Internet. For example, the data stream is synchronizedly duplicated at multiple servers of multiple entities at different locations to ensure of its ubiquitousness. Further, the data stream is immutable, e.g., the entries of the data stream are practically unchangeable after a short time period, such as a few minutes. For example, the data stream can be in the form of a link list, with a new entry containing a copy of at least a portion of a previous entry, such as a summary of the previous entry.

Further, the data stream is randomly generated, e.g., the entries of the data stream are practically impossible to predict in advance. For example, the data stream can contain records of transactions of an item, such as the transactions of a cryptocurrency, the transactions of a stock, or transactions of a business. Since the transactions occur based on different factors, it is nearly impossible to predict in advance. Further, the entries of the data stream are significantly different from each other, in order to be easily distinguished from each other. For example, the entries can be hashes with an encryption, such as a 256-bit hash algorithm. Even though two entries are only a few percent different, such as two long strings with only one word or one letter difference, the hashes of the two strings are completely different.

In some embodiments, the present invention discloses systems and methods for time stamping a digital representation of a physical object. The digital representation can be formed by capturing radiation interacted with the physical object, with the radiation generated from one or more radiation sources. The time stamping process utilizes a ubiquitous data stream that includes random and immutable data, as disclosed above.

In some embodiments, used in conjunction with a requirement that the time of digitalization is recent, such as less than 1 day from the current time, the present time stamped digitalized representation can also certify the current ownership of the object, e.g., the claimant is the current owner of the object.

In some embodiments, a user-input component is included in the system to identify the claimant, e.g., who currently possesses of the object being imaged. This input must also be contained within the tamper-proof casing, and can include biometric measurements or a keypad to manually type a personal code. Using the user input capability; the digitization can be certified as having had both the owner and the object physically present at the time of scanning.

In some embodiments, a portable system, e.g., a system without network connectivity, can be used to perform the time stamp operation. Data from the blockchain can be downloaded to a memory of the portable system, with the memory constantly updated whenever the portable system can be connected to the network.

### BRIEF DESCRIPTION OF THE DRAWINGS

FIG. 1 illustrates a schematic configuration for time stamping a document according to some embodiments.

FIGS. 2A-2B illustrate flow charts for forming systems for time stamping a document according to some embodiments.

FIGS. 3A-3C illustrate flow charts for time stamping a document according to some embodiments.

FIGS. 4A-4C illustrate schematic for data streams according to some embodiments.

FIGS. 5A-5C illustrate flow charts for data streams according to some embodiments.

FIGS. 6A-6B illustrate a schematic for a direction connection with a data stream according to some embodiments.

FIGS. 7A-7B illustrate a schematic for a tamper-proof environment for a system configured to time stamping a document according to some embodiments.

FIG. 8 illustrates a schematic configuration for time stamping a physical object according to some embodiments.

FIG. 9 illustrates a schematic flow for time stamping a physical object according to some embodiments.

FIG. 10 illustrates a flow chart for forming systems for time stamping a physical object according to some embodiments.

FIGS. 11A-11B illustrate flow charts for time stamping a physical object according to some embodiments.

FIGS. 12A-12B illustrate schematic configurations for capturing representations of a physical object according to some embodiments.

FIG. 13 illustrates a flow chart for forming systems for capturing representations of a physical object according to some embodiments.

FIGS. 14A-14B illustrate a schematic for a tamper-proof environment for a system configured to time stamping a physical object according to some embodiments.

FIG. 15 illustrates a schematic configuration for a system configured to time stamping a physical object with owner data according to some embodiments.

FIG. 16 illustrates a flow chart for forming systems for time stamping a physical object with owner data according to some embodiments.

FIGS. 17A-17B illustrate flow charts for time stamping a physical object with owner data according to some embodiments.

FIGS. 18A-18B illustrate a schematic configuration and flow for an off-line system configured to time stamping a physical object according to some embodiments.

FIG. 19 illustrates a flow chart for forming systems for off-line time stamping a physical object according to some embodiments.

FIGS. 20A-20B illustrate flow charts for off-line time stamping a physical object according to some embodiments.

### DETAILED DESCRIPTION OF THE EMBODIMENTS

Time Stamping a Document

In some embodiments, the present invention discloses systems and methods for time stamping with low cost and simplicity. The time stamping process utilizes a data stream that is synchronized ubiquitous around the world, e.g., the data stream can be found at any location having access to the Internet. For example, the data stream is synchronizedly duplicated at multiple servers of multiple entities at different locations to ensure of its ubiquitousness.

Further, the data stream is immutable, e.g., the entries of the data stream are practically unchangeable after a short time period, such as a few minutes. For example, the data stream can be in the form of a link list, with a new entry containing a copy of at least a portion of a previous entry, such as a summary of the previous entry. Thus, after a few new entries, such as after 6 or 12 new entries, after the current entry, the current entry is practically unchangeable, since changing it requires changing also all the entries after. For example, with new entries added every 6 seconds, after a few minutes, there are enough entries in the data stream to ensure immutability.

Further, the data stream is randomly generated, e.g., the entries of the data stream are practically impossible to predict in advance. For example, the data stream can contain records of transactions of an item, such as the transactions of a cryptocurrency, the transactions of a stock, or transactions of a business. Since the transactions occur based on different factors, it is nearly impossible to predict in advance.

Further, the entries of the data stream are significantly different from each other, in order to be easily distinguished from each other. For example, the entries can be hashes with an encryption, such as a 256-bit hash algorithm. Even though two entries are only a few percent different, such as two long strings with only one word or one letter difference, the hashes of the two strings are completely different.

In some embodiments, the data stream can have multiple entries, with each entry associated with a time, e.g., the time of the entry, such as the time that the entry is entered into the data stream. The data stream can have entries having a time field and a data field. Alternatively, the entries can have the times embedded in the entries.

Thus, by using an entry, the time can be found by matching the entry with the data stream, and looking for the corresponding time. Alternatively, the entry and the time can be used, with the time used for finding the entry in the data stream, and the entry for authenticate the time.

In some embodiments, the invention discloses a method for time stamping using entries of a ubiquitous data stream having recently randomly generated immutable data, e.g., the data stream is ubiquitous, the entries in the data are practically impossible to predict in advance or changed after a short time. Each entry of the data stream can be used to denote the time, e.g., to time stamping with the entry, which can be verified everywhere and which is impractical to be forged.

In some embodiments, the time stamp can be used in a digital document to certify the time of the document. For example, the time stamp can be used to show the time that the document is created or signed.

In some embodiments, the present time stamping process can be simple, low cost, and without a need to depend on other services. The only requirement for the time stamping process is an access to the data stream, such as to have access to the Internet. Further, the Internet access is not required to be continuous. For example, the data stream can be downloaded, and regularly updated, to a local memory. The time stamping process can be performed off-line until the Internet access is restored to update the data stream.

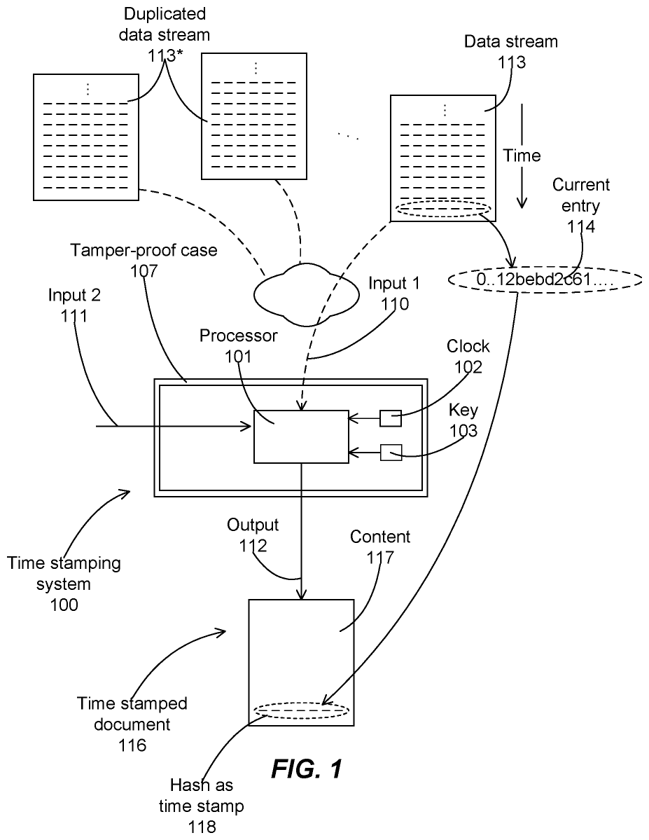

FIG. 1 illustrates a schematic configuration for time stamping a document according to some embodiments. A time stamping system 100 can include a processing component, such as a processor 101, with access to a data stream 113. The data stream can be duplicated, e.g., having multiple duplicated data streams 113* by different servers at different locations. The data stream can be a ubiquitous data stream of recently randomly generated immutable entries 114. The entries can be in the form of hashes, such as 256 bit hashes calculated from a hash algorithm.

The processor can be a microprocessor or a field-programmable gate array (FPGA) with an integrated input connection 110 to a network, such as the Internet. The processor can be configured, e.g., programmed, to obtain one or more entries 114 from the data stream 113, through the input connection 110. For example, the processor can be configured to obtain one entry from the data stream, with the entry functioned as a time stamp.

In some embodiments, the system can have a clock 102, such as an internal clock in the processor, or an external clock for keeping track of the time, such as to time stamp a document with the current time provided by the clock. The current time, e.g., the real time of the time that the time stamping process occurs, can be optional incorporated into the time stamped document.

In some embodiments, the time to be stamped is the current time, e.g., the time that the time stamping process occurs. However, the time from the entry can be the same or can be a different time from the current time, as long as it is pre-determined by the processor.

For example, the processor can be set to use the current time when finding the entry in the data stream. In that case, the most recent entry of the data stream can be used, since it corresponds to a time closest to the current time. The most recent entry can be the most vulnerable, e.g., the least immutable, because there is not yet any entry linked to the most recent entry. Thus, in some embodiments, a verification process can be performed after a time period to ensure that the entry selected by the processor has not been changed, and also to ensure that there are at least a predetermined number of newer entries after the selected entry. The predetermined number can be 6 or greater, or 12 or greater, or 20 or greater. By having some newer entries, the immutability of the selected entry can be significantly increased.

The verification process can be performed after the system finishes performing other tasks, or the system can wait after a fixed amount of time, such as after 30 seconds, after 1 minute, after 90 seconds, or after 2 minutes. In some embodiments, the wait time can depend on the number of newer entries after the selected entry. For example, if after a fixed wait time, the number of entries is still too small, e.g., lower than a predetermined number, the wait time can increase until the number of entries is greater than the predetermined number.

Alternatively, the processor can be set to use a previous entry, such as an entry separated by a fixed number before the most recent entry. In that case, the entry preceding the most recent entry for the fixed number of entries can be used. For example, the most recent entry can be first identified, then the entries can be counted backward from the most recent entry until reaching the desired entry separated by the predetermined fixed number, and the desired entry can be used as the time stamp. The actual time of the entry used as the time stamp is not determined beforehand, and can be determined from the entry itself. An advantage of using a previous entry is the immutable characteristic of the entry, since the previous entries are more difficult to be tampered with as compared to later entries.

Alternatively, the processor can be set to use a previous time, such as a time separated by a fixed time period before the current time. In that case, the entry preceding the most recent entry for the fixed time period can be used. For example, a most recent entry can be first identified, then the time of the most recent entry is determined, then the entries can be traced backward from the most recent entry until reaching the desired entry having the predetermined time, e.g., having the time that is separated by the time period before the current time, and the desired entry can be used as the time stamp. The time of the entry can be not exact, since the entries can be added to the data stream at different interval. Similar to using a previous entry, an advantage of using an entry of a previous time is the immutable characteristic of the entry, since the entry of a previous time is a previous entry, and is more difficult to be tampered with as compared to later entries.

In some embodiments, the system can have an input 111, such as for inputting a document to be time stamped. For example, the processor 101 can obtains an entry from the data stream at a data stream input 110, and a document from another input 111. The processor can combine the entry with the document to form a time stamped document, with an optional real time incorporated in the time stamped document.

In some embodiments, the system can have an output 112, which is configured to output the time stamped document 116, e.g., a document containing a document content 117 and a time stamp 118, which is the entry of the data stream. The entry can be a hash. The output can be a data transfer cable.

In some embodiments, the inputs 110, 111, and the output 112 are coupled directly to the processor 101, to prevent tampering such as interfering with the input or output.

The processor can be configured to execute a set of pre-loaded and updatable digital instructions in a logical manner, which will be referred to as a program. For example, the processor has a pre-loaded program, and performs computations on the data that it receives directly from the inputs. These computations can include control system feedback, hashing, cryptographic encryption, transaction signing.

In some embodiments, the system can have a small number of secret keys, which can be used to digitally sign and thereby certify the created file outputs, or can be used to encrypt the signed file. The secret keys can include a first private cryptographical key, which can be used to encrypt a system signature for digital signing. The secret keys can include a second private cryptographical key, which can be used to encrypt the signed file. The first and second cryptographical keys can be the same or can be two different keys. Once the time stamped datafile is signed and encrypted, it is emitted, e.g., output for further processing, or to have the signed and encrypted time stamped datafile broadcast throughout the world, for example, in a public blockchain.

When the output file is received, the output file can be decrypted with a matching second public key, to receive a time stamped document and a digital signature. The digital signature is decrypted with a matching first public key to generate a signature hash. The time stamped document can be hashed, and the hash is compared with the signature hash, decrypted from the digital signature. If the two hashes matched, the time stamped document is not tampered.

In some embodiments, the system can be configured to be protected from being tampered, such as to prevent attempts to modify the inputs, the output, or the time stamping process. For example, the processor can be configured with direct inputs and output in an impenetrable way, e.g., the processor can recognize the inputs and output coming to and going out from the processor to prevent changes to the time stamping process.

In some embodiments, the system can be encased in a tamper-proof environment, e.g., the critical component of the processor with the inputs and output can be housed in the tamper-proof environment, which is to prevent tampering. For example, if the casing is in any way damaged, such as being probed, punctured, or otherwise broken, the secret keys or the program in the processor can be immediately erased to render the entire system unable to certify any subsequent digitization.

In some embodiments, the system can include a control unit, such as a computer or a controller running a program to organize the operation of the individual components. For example, a control unit with a logically flowing program can be used. For example, the control unit can be a computer or a controller connected to the multiple system components via conducting cables that are able to transmit start/stop and optionally more sophisticated control messages. As an example, the time stamp process can be initiated by a triggering signal to the control unit.

In operation, the system can include the following steps. At step 1, the control unit is triggered, for example, through a signal, such as an operator pushing a start button. At step 2, after the start button is pressed, the processor notes the time, for example, by getting the time from a clock. The processor can create a start token, for example, by getting a value in the data stream, such as the most recent value, or a value separated by the most recent value by a fixed number, or a value separated the most recent value by a fixed time.

At step 3, the processor obtains a document in a digital format, such as a soft copy of the document. At step 4, the processor combines the start token and the digital document into a datafile, such as a binary datafile. The processor then digitally signs and encrypts the datafile. At step 5, the processor then transmits the signed and encrypted datafile through the output stream, which can be used for further processing, for example for use in relation to non-fungible token minting or creation. For example, the signed and encrypted datafile can be used to form a non-fungible token, or can be embedded as a transaction in a blockchain.

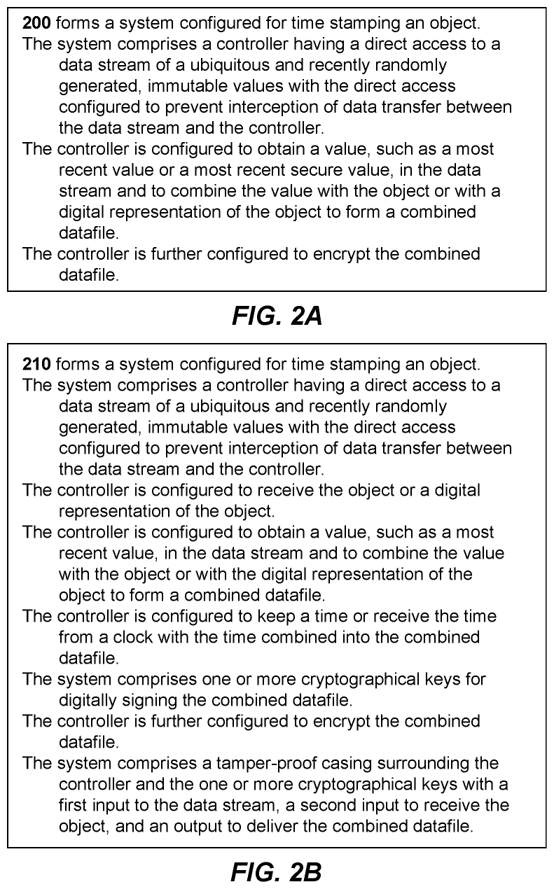

FIGS. 2A-2B illustrate flow charts for forming systems for time stamping a document according to some embodiments. In FIG. 2A, operation 200 forms a system configured for time stamping an object. The system comprises a controller having a direct access to a data stream of a ubiquitous and recently randomly generated, immutable values with the direct access configured to prevent interception of data transfer between the data stream and the controller.

The controller is configured to obtain a value, such as a most recent value or a most recent secure value, in the data stream and to combine the value with the object or with a digital representation of the object to form a combined datafile. The controller is further configured to encrypt the combined datafile.

In FIG. 2B, operation 210 forms a system configured for time stamping an object. The system comprises a controller having a direct access to a data stream of a ubiquitous and recently randomly generated, immutable values with the direct access configured to prevent interception of data transfer between the data stream and the controller.

The controller is configured to receive the object or a digital representation of the object. The controller is configured to obtain a value, such as a most recent value, in the data stream and to combine the value with the object or with the digital representation of the object to form a combined datafile. The controller is configured to keep a time or receive the time from a clock with the time combined into the combined datafile.

The system comprises one or more cryptographical keys for digitally signing the combined datafile. The controller is further configured to encrypt the combined datafile. The system comprises a tamper-proof casing surrounding the controller and the one or more cryptographical keys with a first input to the data stream, a second input to receive the object, and an output to deliver the combined datafile.

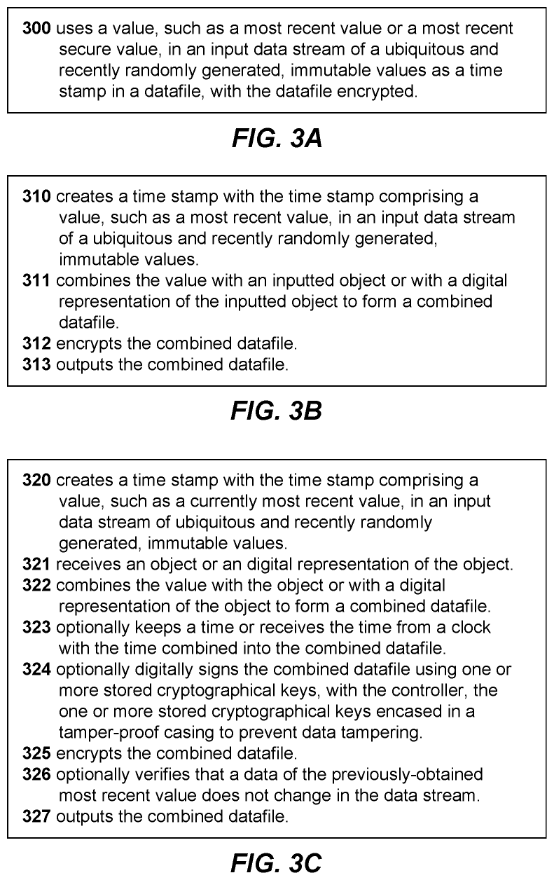

FIGS. 3A-3C illustrate flow charts for time stamping a document according to some embodiments. In FIG. 3A, operation 300 uses a value, such as a most recent value or a most recent secure value, in an input data stream of a ubiquitous and recently randomly generated, immutable values as a time stamp in a datafile, with the datafile encrypted. For example, a value obtained in an input data stream of a ubiquitous, immutable, and random data stream can be used as a time stamp in a datafile.

In FIG. 3B, operation 310 creates a time stamp with the time stamp comprising a value, such as a most recent value, in an input data stream of a ubiquitous and recently randomly generated, immutable values. Operation 311 combines the value with an inputted object or with a digital representation of the inputted object to form a combined datafile. Operation 312 encrypts the combined datafile. Operation 313 outputs the combined datafile.

In FIG. 3C, operation 320 creates a time stamp with the time stamp comprising a value, such as a currently most recent value, in an input data stream of ubiquitous and recently randomly generated, immutable values. Operation 321 receives an object or a digital representation of the object. Operation 322 combines the value with the object or with a digital representation of the object to form a combined datafile. Operation 323 optionally keeps a time or receives the time from a clock with the time combined into the combined datafile. Operation 324 optionally digitally signs the combined datafile using one or more stored cryptographical keys, with the controller, the one or more stored cryptographical keys encased in a tamper-proof casing to prevent data tampering. Operation 325 encrypts the combined datafile. Operation 326 optionally verifies that a data of the previously-obtained most recent value does not change in the data stream. Operation 327 outputs the combined datafile.

Blockchain

For the purpose of denoting a certified timestamp, the processing component will need to have access to a ubiquitous, immutable, and randomly generated data stream. Ubiquity and immutability are imperative for corroboration of the certified start timestamp by any external party. Randomness is imperative so that the start token cannot be predicted before the actual start of the current acquisition.

In some embodiments, a blockchain can be used as a data stream for the time stamping process. A blockchain, such as a public blockchain, can meet the requirements of the data stream, such as being ubiquitous, since the public blockchain is copied by multiple servers throughout the world, such as having immutable data, since the blocks in the blockchain are linked together, with the block header of a block containing the block header of a previous block, thus after a few blocks, the blocks are practically unchangeable, since it would mean changing all subsequent blocks, and such as recently randomly generated data, since the blocks include transactions with a characteristic that requires nodes to compete with each other go gain access for forming the blocks.

For example, the Ethereum blockchain, or other cryptocurrency blockchains, can be used as the required data stream. Specifically, the chain of blocks, or the sequence of block headers, e.g., headers of the blocks, which can be in the form of hashes, can be used. For all practical purposes, e.g., with extremely low probability of failure, this stream satisfies the stated conditions: blocks or block hashes are synchronized ubiquitously throughout the world, are nearly impossible to predict even one minute in advance, and are practically immutable once a few minutes have passed.

Blockchain is kept in a decentralized database, which is a distributed storage system which includes multiple nodes that communicate with each other. A blockchain configured to include an append-only immutable data structure resembling a distributed ledger capable of maintaining records between mutually untrusted parties. Each party maintains a copy of the database records and no single party can modify the database records without a consensus being reached among the distributed parties. For example, the parties can execute a consensus protocol to validate blockchain storage transactions, group the storage transactions into blocks, and build a hash chain over the blocks.

A chain is a transaction log which is structured as hash-linked blocks, and each block contains a sequence of multiple transactions. The block header includes a hash of the block's transactions, as well as a hash of the prior block's header. In this way, all transactions on the ledger may be sequenced and cryptographically linked together.

A block in a blockchain is a collection of transactions. The block includes a block header, which provides a summary of the block, followed by a list of transactions in the block. A block header includes a reference to a previous block header hash, which connects this block to the previous block in the blockchain. The block header can include a time stamp, together with other metadata. The block header serves as an efficient summary of a block and can be sent across the network and processed more rapidly than a full block.

The primary identifier of a block is its cryptographic hash, made by hashing the block header twice through the SHA256 algorithm. The resulting hash is called the block hash but is more accurately the block header hash, because only the block header is used to compute it.

In some cases, the block hash is not actually included inside the block, or transmitted on the network, or stored on a node storage. Instead, the block hash can be computed by each node as the block is received from the network. The block hash can be stored in a separate database table, e.g., a sequence of block hashes, to facilitate indexing and faster retrieval of blocks.

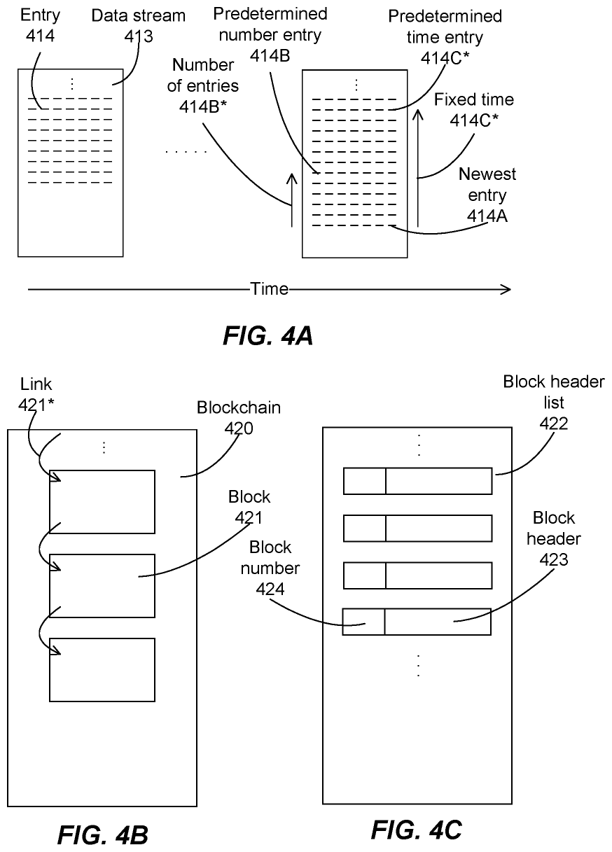

FIGS. 4A-4C illustrate schematic for data streams according to some embodiments. In FIG. 4A, a data stream 413 can include multiple entries 414, which grow with time. A newest entry 414A can be the most recent entry in a data stream. A predetermined number entry 414B can be the entry that is separated from the newest entry 414A by a predetermined number 414B*. When the predetermined number 414B* is a smallest number that can provide practical immutability to the entry, the predetermined number entry 414B can be called the latest confirmed entry, such as the latest confirmed block in a blockchain. For example, in Bitcoin, the latest confirmed block is the block with the predetermined number 414B* is 6.

A predetermined time entry 414C can be the entry that is separated from the newest entry 414A by a predetermined time 414C*. For example, the predetermined time 414C* can be one hour, 2 hours, or 10 hours. The predetermined time entry 414C can be more secured than the newest entry, but the degree of immutability can be non-linear for longer time. Thus, a very long predetermined time does not provide significant advantages.

FIG. 4B shows a blockchain 420 having each blocks 421 linked 421* to a previous block. FIG. 4C shows a list of block header, such as sequence of block hashes or block header hashes. The sequence 422 of block hashes can include multiple block headers 423 in the form of hashes, e.g., block hashes or block header hashes. The sequence can include identifiers, such as block number 424, to identify the block header 423.

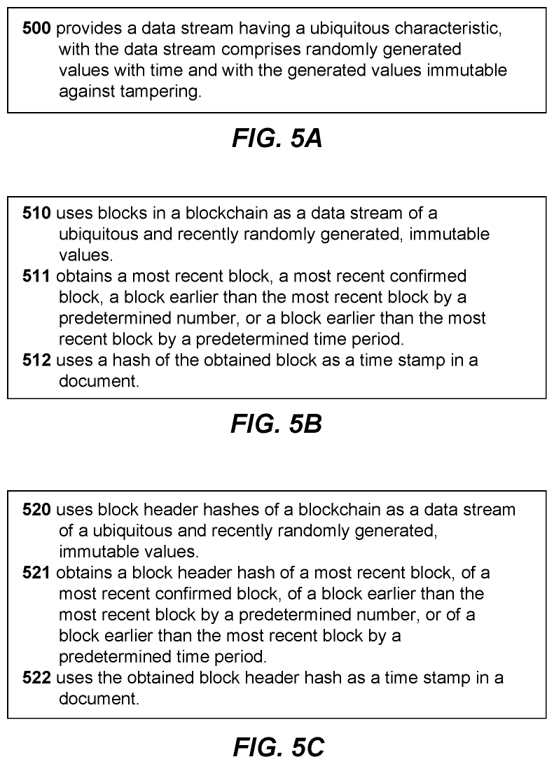

FIGS. 5A-5C illustrate flow charts for data streams according to some embodiments. In FIG. 5A, operation 500 provides a data stream having a ubiquitous characteristic, with the data stream comprises randomly generated values with time and with the generated values immutable against tampering.

In FIG. 5B, operation 510 uses blocks in a blockchain as a data stream of a ubiquitous and recently randomly generated, immutable values. Operation 511 obtains a most recent block, a most recent confirmed block, a block earlier than the most recent block by a predetermined number, or a block earlier than the most recent block by a predetermined time period. Operation 512 uses a hash of the obtained block as a time stamp in a document.

In FIG. 5C, operation 520 uses block header hashes of a blockchain as a data stream of a ubiquitous and recently randomly generated, immutable values. Operation 521 obtains a block header hash of a most recent block, of a most recent confirmed block, of a block earlier than the most recent block by a predetermined number, or of a block earlier than the most recent block by a predetermined time period. Operation 522 uses the obtained block header hash as a time stamp in a document.

Tamper-Proof Enclosure

In some embodiments, the system is configured to be tamper-proof, for example, through direct connections to inputs and outputs, together with encasing the tamperable components in a tamper-proof enclosure.

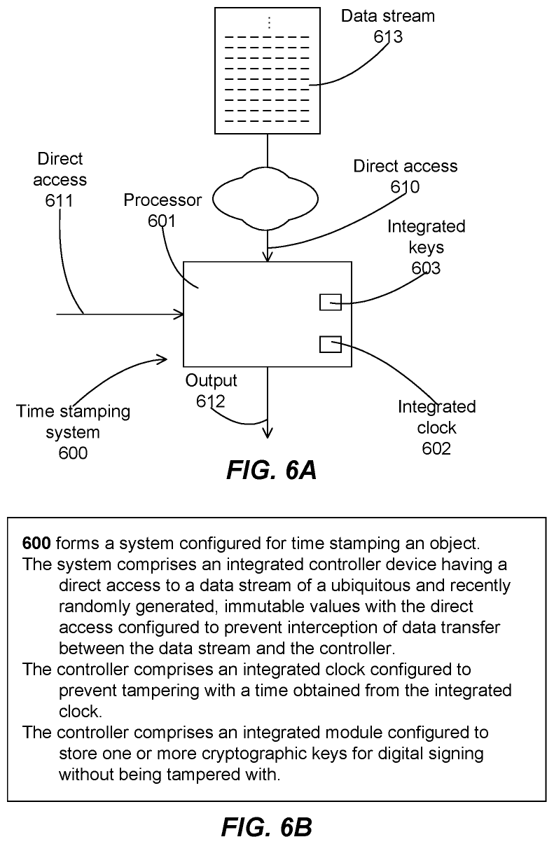

FIGS. 6A-6B illustrate a schematic for a direction connection with a data stream according to some embodiments. FIG. 6A shows a time stamping system 600 having an integrated processor 601, which is configured to have an integrated clock 602, and an integrated memory to store one or more cryptographical keys 603. In addition, the processor 601 can have direct access inputs 610 and 611, for example, for connection to a data stream 613 and a document. The direct access inputs can prevent tampering, such as intercepting the incoming inputs and replace them with other data. The processor 601 can have a direct access output 612, for example, for outputting a certified datafile. The certified datafile can be signed and encrypted at the direct access output, so that there can be no tampering, such as changing the datafile before being protected.

In FIG. 6B, operation 600 forms a system configured for time stamping an object. The system comprises an integrated controller device having a direct access to a data stream of a ubiquitous and recently randomly generated, immutable values with the direct access configured to prevent interception of data transfer between the data stream and the controller. The controller comprises an integrated clock configured to prevent tampering with a time obtained from the integrated clock. The controller comprises an integrated module configured to store one or more cryptographic keys for digital signing without being tampered with.

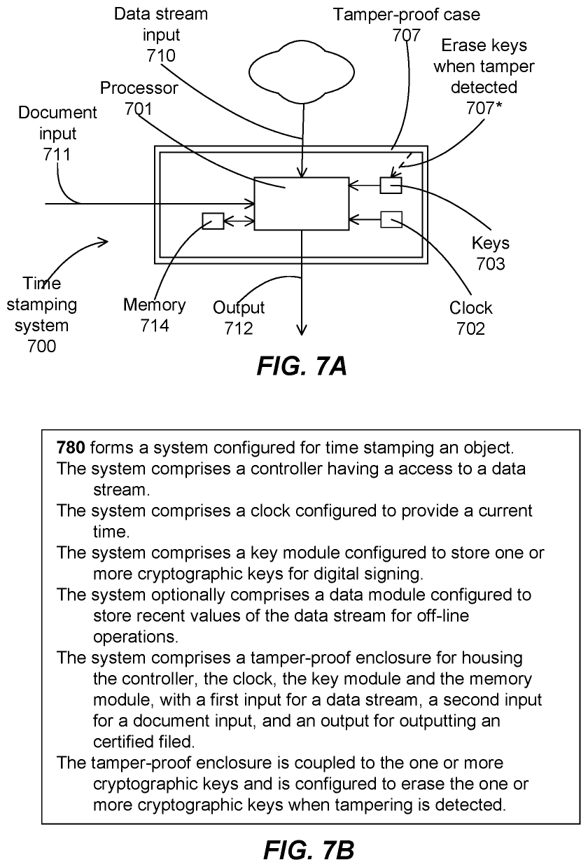

FIGS. 7A-7B illustrate a schematic for a tamper-proof environment for a system configured to time stamping a document according to some embodiments. In FIG. 7A, a time stamping system 700 can have a processor 701, a clock 702, one or more cryptographical keys 703, and an optional memory 704 enclosed in a tamper-proof enclosure 707. The tamper-proof enclosure can be equipped with one or more sensors to detect a tampering action, such as an accelerometer to detect a shock to the enclosure, a pressure sensor in the enclosure to detect an air leak, such as a hole through the enclosure by drilling, or a surface sensor to detect a surface deform, such as a dent to the enclosure.

When a tampering action is detected, the tamper-proof enclosure can be configured to erase the cryptographical keys 703. Alternatively, or additionally, the tamper-proof enclosure can be configured to erase the program in the processor 701. Thus, after detecting a tampering action on the tamper-proof enclosure, the system is not capable of perform any further work on generating a time stamped document.

In some embodiments, the enclosure can be configured to cover the inputs, such as data stream input 710 and document input 711, and output 712 to protect the integrity of the incoming and outgoing data.

In FIG. 7B, operation 780 forms a system configured for time stamping an object. The system comprises a controller having an access to a data stream. The system comprises a clock configured to provide a current time. The system comprises a key module configured to store one or more cryptographic keys for digital signing. The system optionally comprises a data module configured to store recent values of the data stream for off-line operations. The system comprises a tamper-proof enclosure for housing the controller, the clock, the key module and the memory module, with a first input for a data stream, a second input for a document input, and an output for outputting a certified filed. The tamper-proof enclosure is coupled to the one or more cryptographic keys and is configured to erase the one or more cryptographic keys when tampering is detected.

Time Stamp a Physical Object

In this day in age when ownership of valuable objects is increasingly being misrepresented, it is important to certify that ownership of a particular object is indeed that which is claimed. Since a digitalized representation of a physical object is being increasingly popular, ownership of an object can be started with the digitalized representation, with the digitalized representation having some aspects of the object unique structures in a manner that is amenable to re-identification at a later time.

However, nothing currently stops a bad actor from counterfeiting the digitized version of a valuable object (which may even have initially been genuinely authenticated) and presenting it at a later time, even though they no longer have access to the original object in question.

In some embodiments, the present time stamped digitalized representation of an object can ensure that the digitization of the object can be genuinely certified only if that object is physically present at the time and place of digitization.

In some embodiments, used in conjunction with a requirement that the time of digitalization is recent, such as less than 1 day from the current time, the present time stamped digitalized representation can also certify the current ownership of the object, e.g., the claimant is the current owner of the object.

In some embodiments, the present invention discloses systems and methods for time stamping a digital representation of a physical object. The digital representation can be formed by capturing radiation interacted with the physical object, with the radiation generated from one or more radiation sources. The time stamping process utilizes a ubiquitous data stream that includes random and immutable data, as disclosed above.

In some embodiments, the time stamping process can be used to generate a time stamped datafile, with the datafile including a time stamped representation of a physical object. The time stamped datafile can be used to certify that the physical object, and optionally the claimed owner, is necessarily physically present at the time of the digitization of the object. The physical presence can certify ownership of the object at the digitalization time, e.g., at the time identified by the time stamp in the datafile.

In some embodiments, the present invention discloses a system to generate a time stamped datafile that digitally certifies an object, and ensures that such certified digitization can only occur if that object is physically present at the time and place of digitization. This is achieved through the combination of proof-of-time (leveraging time stamping process using a randomly generated and immutable sequence), and proof-of-presence (leveraging tamper-proof processing components combined with secure digital signatures).

In some embodiments, the time stamped datafile can be used to certify a current ownership of the object, e.g., showing that the claimant indeed has ownership of the object at the present time, if the time in the time stamp is recent, e.g., not far from the time of proving the ownership. For example, if a claimant has a time stamped datafile of today, it is certified that the claimant indeed has ownership of the object today.

In general, ownership and authenticity of an artwork must be certifiable for the high-value-art market to properly function. In some embodiments, the present time stamped datafile of a digital representation of an object can be used to certify ownership of the object at the time in the time stamp in the datafile. In some embodiments, the time stamped datafile can be used to certify current ownership of the object, by noting that the time in the time stamp is recent, e.g., close to the current time. Thus, the present time stamped datafile of a digital representation of an object can prevent a fraudster to feign current ownership, for example, by the fraudster obtaining or forging the digitization of the object, even after possibly the fraudster having had possession of the object at some point in the past.

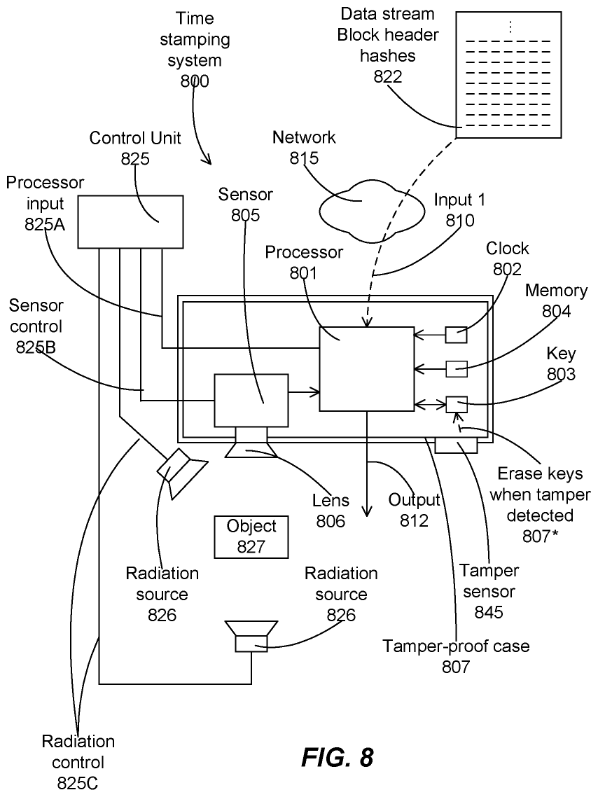

FIG. 8 illustrates a schematic configuration for time stamping a physical object according to some embodiments. A time stamping system 800 can include a radiation emitting component, such as one or more radiation sources 826. Possible types of radiation can include visible light, infra-red, ultra-violet, x-rays, filtered light, e.g., through polarization filters or fluorescence filters, and other forms of electromagnetic radiation that are suitable for the purpose of imaging an object. Mechanical radiation such as ultrasound and sonar, as well as electron beams (i.e. as part of an electron microscope) or other subatomic transmission devices can also be used.

The time stamping system 800 can further include a radiation sensing component, such as one or more sensors or sensor arrays 805, e.g., charge-coupled devices (CCD) and/or CMOS sensor arrays. Each sensor or sensor array can include a lens 806, for focusing or for magnification. The sensing component can function to convert the incoming radiation to the sensing component into a digital stream, which can be interpreted as the strength of response at a specific sensing location and incoming direction. A focusing system (e.g. optical lenses or electromagnetic beam focusers) can be used as intermediate layers between the object being imaged and the sensing component.

In operation, the radiation emitting component can emit radiation to the object, for example, a radiation component of a light source can emit visible light to the object. The radiation interacts with the object, such as being absorbed, scattered, or reflected. The interacted radiation then can be captured by the radiation sensing component, for example, a radiation sensing component of a camera sensor array can capture the interacted light, e.g., absorbed, reflected, scattered or transmitted from the object. Information captured by the camera sensor array can be transmitted in the form of a digital data stream to a processor for processing, such as for forming images of the object.

For example, sets of the radiation emitting component and the radiation sensing component can include a lighting unit and a high resolution camera array, an optical or electron microscope, an x-ray machine, and any combination of the above radiation, emission, and digital detection schemes. Together, the radiating and sensing components interact and output what can be referred to interchangeably as a “scan”, “acquisition”, or “image”. Such scans are not limited to 2 dimensions, but can be acquired in multiple dimensions, from multiple directions, and at multiple times, such as forming videos or other high-dimensional output datafiles.

In some embodiments, the sets of radiation emitting and sensing components can be configured to be movable or adjustable. For example, the radiation sensing component can be adjustable, such as adjusting magnifications, or adjusting focus depth planes. The radiation sensing component can be movable, such as scanning along a lateral direction to capture different areas of the object, or moving along an axial direction perpendicular to the lateral plane to change a focus depth plane. The radiation emitting component can be individually changed to form different illumination patterns to the object, such as to generate a dark field, a bright field, a scattering illumination or a transissive illumination.

The time stamping system 800 can further include a processing component, such as a processor 801, with access to a data stream, such as a sequence of block header hashes 822. The processor can be a microprocessor or a field-programmable gate array (FPGA) with an integrated input connection 810 to a network, such as the Internet. The processor can be configured, e.g., programmed, to obtain one or more block header hashes (or block hashes) from the sequence of block header hashes, through the input connection 810. For example, the processor can be configured to obtain one block header hash from the block header hash sequence, with the block header hash functioned as a time stamp.

In some embodiments, the system can have a clock 802, such as an internal clock in the processor, or an external clock for keeping track of the time, such as to time stamp a document with the current time provided by the clock. The current time, e.g., the real time of the time that the time stamping process occurs, can be optional incorporated into the time stamped document.

In some embodiments, the time to be stamped is the current time, e.g., the time that the time stamping process occurs. However, the time from the block header hash can be the same or can be a different time from the current time, as long as it is pre-determined by the processor.

For example, the processor can be set to use the current time when finding the block header hash in the block header hash sequence. In that case, the most recent block header hash of the block header hash sequence can be used, since it corresponds to a time closest to the current time. The most recent block header hash can be the most vulnerable, e.g., the least immutable, because there is not yet any block linked to the most recent block. Thus, in some embodiments, a verification process can be performed after a time period to ensure that the block header hash selected by the processor has not been changed, and also to ensure that there are at least a predetermined number of newer block after the selected block. The predetermined number can be 6 or greater, or 12 or greater, or 20 or greater. By having some newer blocks, the immutability of the selected block can be significantly increased.

The verification process can be performed after the system finishes performing other tasks, or the system can wait after a fixed amount of time, such as after 30 seconds, after 1 minute, after 90 seconds, or after 2 minutes. In some embodiments, the wait time can depend on the number of newer blocks after the selected block. For example, if after a fixed wait time, the number of blocks is still too small, e.g., lower than a predetermined number, the wait time can increase until the number of blocks is greater than the predetermined number.

Alternatively, the processor can be set to use a previous block header hash, such as a block header hash separated by a fixed number before the most recent block header hash. In that case, the block header hash preceding the most recent block header hash for the fixed number of block header hashes can be used. For example, the most recent block header hash can be first identified, then the block header hashes can be counted backward from the most recent block header hash until reaching the desired block header hash separated by the predetermined fixed number, and the desired block header hash can be used as the time stamp. The actual time of the block header hash used as the time stamp is not determined beforehand, and can be determined from the block header hash itself, e.g., from the block header or the block identified by the block header hash. An advantage of using a previous block header hash is the immutable characteristic of the block, since the previous blocks are more difficult to be tampered with as compared to later blocks in the blockchain.

Alternatively, the processor can be set to use a previous time, such as a time separated by a fixed time period before the current time. In that case, the block header hash preceding the most recent block header hash for the fixed time period can be used. For example, a most recent block header hash can be first identified, then the time of the most recent block header hash is determined, then the block header hashes can be traced backward from the most recent block header hash until reaching the desired block header hash having the predetermined time, e.g., having the time that is separated by the time period before the current time, and the desired block header hash can be used as the time stamp. The time of the block header hash can be not exact, since the block header hashes can be added to the data stream at different interval. Similar to using a previous block header hash, an advantage of using a block of a previous time is the immutable characteristic of the block, since the block of a previous time is a previous block, and is more difficult to be tampered with as compared to later blocks.

In some embodiments, the processor can have a connection with the radiation sensing component, such as the sensor 805, for inputting a data stream captured by the sensor 805. The processor can be configured to process the data stream to a digitalized representation of the object 827. For example, the processor 801 can obtains a block header hash from the sequence of block header hashes at input 810. The processor can combine the block header hash with the digitalized representation to form a time stamped datafile, with an optional real time incorporated in the time stamped datafile.

In some embodiments, the system can have an output 812, which is configured to output the time stamped datafile. The output 812 can be a data transfer cable.

The processor can be configured to execute a set of pre-loaded and updatable digital instructions in a logical manner, which will be referred to as a program. For example, the processor has a pre-loaded program, and performs computations on the data that it receives directly from the inputs. These computations can include feature extraction, Machine Learning pipelines, control system feedback, hashing, cryptographic encryption, or transaction signing.

In some embodiments, the system can have a small number of secret keys, which can be used to digitally sign and thereby certify the created file outputs, or can be used to encrypt the signed file. The secret keys can include a first private cryptographical key, which can be used to encrypt a system signature for digital signing. The secret keys can include a second private cryptographical key, which can be used to encrypt the signed file. The first and second cryptographical keys can be the same or can be two different keys. Once the time stamped datafile is signed and encrypted, it is emitted, e.g., output for further processing, or to have the signed and encrypted time stamped datafile broadcast throughout the world, for example, in a public blockchain.

When the output file is received, the output file can be decrypted with a matching second public key, to receive a time stamped document and a digital signature. The digital signature is decrypted with a matching first public key to generate a signature hash. The time stamped document can be hashed, and the hash is compared with the signature hash, decrypted from the digital signature. If the two hashes matched, the time stamped document is not tampered.

In some embodiments, the system can be configured to be protected from being tampered, such as to prevent attempts to modify the inputs, the output, or the time stamping process. For example, the processor can be configured with direct inputs and output in an impenetrable way, e.g., the processor can recognize the inputs and output coming to and going out from the processor to prevent changes to the time stamping process.

In some embodiments, the system can be encased in a tamper-proof enclosure 807, e.g., the critical component of the processor and the sensor with the inputs and output can be housed in the tamper-proof environment, which is to prevent tampering. The tamper-proof enclosure can include a window permeable to the interacted radiation, e.g., radiation interacted with the object. The tamper-proof enclosure can be equipped with one or more sensors 845 to detect a tampering action, such as an accelerometer to detect a shock to the enclosure, a pressure sensor in the enclosure to detect an air leak, such as a hole through the enclosure by drilling, or a surface sensor to detect a surface deform, such as a dent to the enclosure. For example, if the enclosure is in any way damaged, such as being probed, punctured, or otherwise broken, the secret keys or the program in the processor can be immediately erased 807* to render the entire system unable to certify any subsequent digitization.

In some embodiments, the system can include a control unit 825, such as a computer or a controller running a program to organize the operation of the individual components. For example, a control unit with a logically flowing program can be used. For example, the control unit can be a computer or a controller connected to the multiple system components via conducting cables that are able to transmit start/stop and optionally more sophisticated control messages. As an example, the time stamp process can be initiated by a triggering signal to the control unit. Also, a processor input 825A can be provided to the processor 801. A sensor control signal 825B can be provided to the sensor 805. Radiation control signals can be provided to the one or more radiation sources 826.

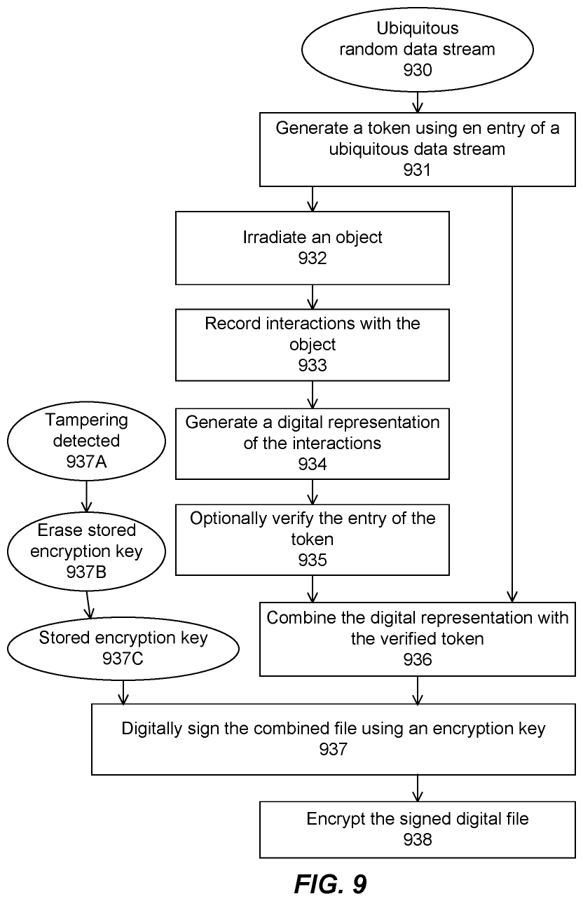

FIG. 9 illustrates a schematic flow for time stamping a physical object according to some embodiments. After the control unit is triggered, for example, through a signal, such as an operator pushing a start button, the processor notes the time, for example, by getting the time from a clock. At operation 931, the processor can create a start token, for example, by getting a value from the data stream 930, such as the most recent value, or a value separated by the most recent value by a fixed number, or a value separated the most recent value by a fixed time.

At operation 932, the control unit can control the radiation emitting component to provide radiation to the object in a specific manner, such as to generate one or more illumination patterns to the object. At operation 933, the control unit then can control the radiation sensing component to sense the radiation as it interacts with the object, e.g. via transmissive, scattered and/or reflective illumination) to generate sensory data, for example in the form of one or more captured images of the object under the emitted radiation.

At operation 934, the processor processes the sensory data into a digital representation of the object, for example, by probing the unique physical characteristics of the object and converting the characteristics to a digitized version of the physical object. For example, the digitalized representation of the physical object can be formed by processing the captured interactive radiation into the digitalized representation, with processing the captured interactive radiation including probing unique physical characteristics of the physical object and converting the characteristics to a digitized format.

At operation 935, the processor can optionally verify the token, such as verify that the value getting from the data stream earlier has not changed. For example, the processor can obtain a most recent value from the data stream to start the token. The most recent value can be most vulnerable for being changed, since there are no values in the data stream related to the most recent value yet. After a short time, such as the time for the radiation generating, capturing, and processing into the digitalized representation, new values can be added to the data stream. The additional values in the data stream after the previously most recent value, e.g., the value taken by the processor to start the token, can added immutability to the taken value, since any changes to the taken value would require changes to subsequent newly added values.

The verification process can occur anytime, such as after the combination operation, after the signing operation, or after the encrypting operation. In some embodiments, the verification process can occur after a predetermined time period, such as 1 minute, 90 seconds, or 2 minutes. In some embodiments, the verification process can occur after a predetermination of number of values added to the data stream, such as after 6, after 12, or after 20 values added after the value taken be the processor as the time stamp.

At operation 936, the processor combines the start token and the digital representation of the physical object into a datafile, such as a binary datafile. The processor then digitally signs and encrypts the datafile. At operations 937 and 938, the processor then transmits the signed and encrypted datafile through the output stream, respectively. The signing and encrypting process can use one or two cryptographical keys, such as private keys in a cryptographical key pair scheme, which can be stored earlier in operation 937C.

The output datafile can be used for further processing, for example for use in relation to non-fungible token minting or creation. For example, the signed and encrypted datafile can be used to form a non-fungible token, or can be embedded as a transaction in a blockchain.

For signing and encrypting, the processor can use cryptographical keys. The presence or absence of the keys can be used to determine if the process of generating the time stamped datafile is tampered. For example, in operation 937A, which runs in parallel with the other operations, the control unit or the process can check the tampering sensors to determine if tampering is detected. If tampering is detected, the cryptographical keys can be erased in operation 937B. The erasing of the cryptographical keys can stop the processor from signing and/or encrypting the combined datafile, which can disable the operation of the time stamping process.

The key erasing in tampering detection can be a simple and cost effective protection against tampering. It can terminate the time stamping process, and at a meantime, allow the system to be minimally damaged, e.g., the system can be restored simply by restoring the cryptographically keys.

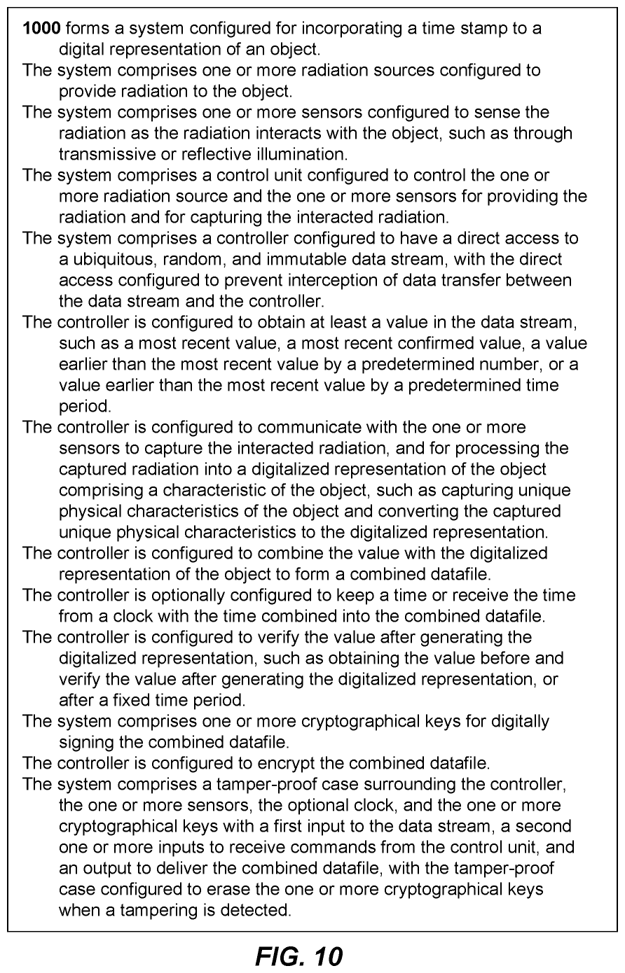

FIG. 10 illustrates a flow chart for forming systems for time stamping a physical object according to some embodiments. Operation 1000 forms a system configured for incorporating a time stamp to a digital representation of an object. The system comprises one or more radiation sources configured to provide radiation to the object. The system comprises one or more sensors configured to sense the radiation as the radiation interacts with the object, such as through transmissive or reflective illumination. The system comprises a control unit configured to control the one or more radiation source and the one or more sensors for providing the radiation and for capturing the interacted radiation. The system comprises a controller configured to have a direct access to a ubiquitous, random, and immutable data stream, with the direct access configured to prevent interception of data transfer between the data stream and the controller.

The controller is configured to obtain at least a value in the data stream, such as a most recent value, a most recent confirmed value, a value earlier than the most recent value by a predetermined number, or a value earlier than the most recent value by a predetermined time period. The controller is configured to communicate with the one or more sensors to capture the interacted radiation, and for processing the captured radiation into a digitalized representation of the object comprising a characteristic of the object, such as capturing unique physical characteristics of the object and converting the captured unique physical characteristics to the digitalized representation. The controller is configured to combine the value with the digitalized representation of the object to form a combined datafile. The controller is optionally configured to keep a time or receive the time from a clock with the time combined into the combined datafile.

The controller is configured to verify the value after generating the digitalized representation, such as obtaining the value before and verify the value after generating the digitalized representation, or after a fixed time period. The system comprises one or more cryptographical keys for digitally signing the combined datafile. The controller is configured to encrypt the combined datafile. The system comprises a tamper-proof case surrounding the controller, the one or more sensors, the optional clock, and the one or more cryptographical keys with a first input to the data stream, a second one or more inputs to receive commands from the control unit, and an output to deliver the combined datafile, with the tamper-proof case configured to erase the one or more cryptographical keys when a tampering is detected.

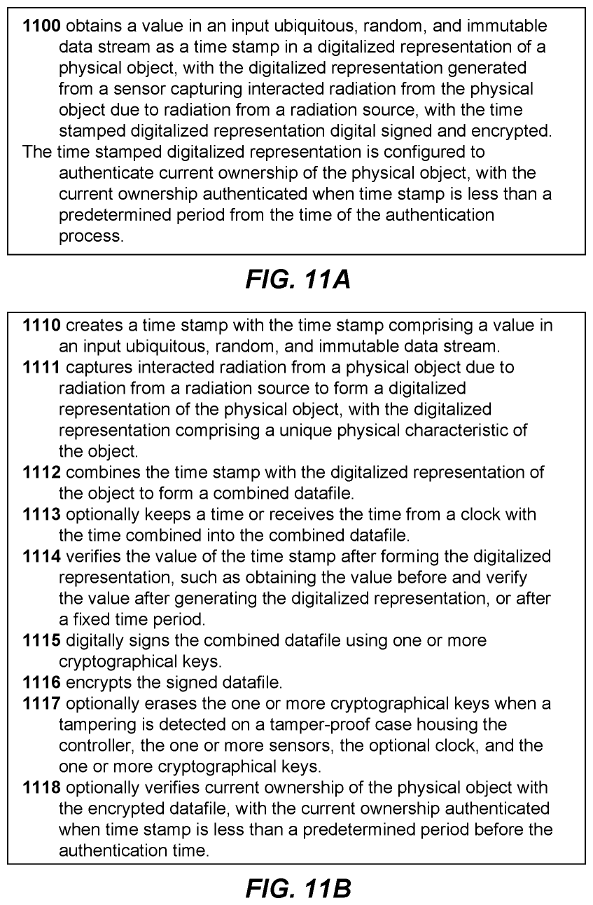

FIGS. 11A-11B illustrate flow charts for time stamping a physical object according to some embodiments. In FIG. 11A, operation 1100 obtains a value in an input ubiquitous, random, and immutable data stream as a time stamp in a digitalized representation of a physical object, with the digitalized representation generated from a sensor capturing interacted radiation from the physical object due to radiation from a radiation source, with the time stamped digitalized representation digital signed and encrypted. The time stamped digitalized representation is configured to authenticate current ownership of the physical object, with the current ownership authenticated when time stamp is less than a predetermined period from the time of the authentication process.

In FIG. 11B, operation 1110 creates a time stamp with the time stamp comprising a value in an input ubiquitous, random, and immutable data stream. Operation 1111 captures interacted radiation from a physical object due to radiation from a radiation source to form a digitalized representation of the physical object, with the digitalized representation comprising a unique physical characteristic of the object. Operation 1112 combines the time stamp with the digitalized representation of the object to form a combined datafile. Operation 1113 optionally keeps a time or receives the time from a clock with the time combined into the combined datafile. Operation 1114 verifies the value of the time stamp after forming the digitalized representation, such as obtaining the value before and verifying the value after generating the digitalized representation, or after a fixed time period. Operation 1115 digitally signs the combined datafile using one or more cryptographical keys. Operation 1116 encrypts the signed datafile. Operation 1117 optionally erases the one or more cryptographical keys when a tampering is detected on a tamper-proof case housing the controller, the one or more sensors, the optional clock, and the one or more cryptographical keys. Operation 1118 optionally verifies current ownership of the physical object with the encrypted datafile, with the current ownership authenticated when time stamp is less than a predetermined period before the authentication time.

Certify Current Ownership

In some embodiments, the time stamping process can be used to certify current ownership, for example, of the physical object that a digitalized representation is time stamped. The time stamped datafile containing the digitalized representation of the physical object with a time stamp can be used to certify ownership of the physical object at the time indicated by the time stamp. The time stamped datafile cannot be used to certify current ownership for a time stamped datafile at a much earlier time, such as 6 months or 1 year earlier, since the claimant could sell the object after generating the time stamped datafile.

In some embodiments, the time stamping process can be used to certify current ownership of the physical object if the time indicated by the time stamp is also current, e.g., recent enough, such as within a few hours or in a same day. The short time difference between the current time and the stamped time can ensure that the ownership of the object has not changed at the current time. The time difference can be less than a few hours, such as less than 1 hour, less than 2 hours, less than 5 hours, or less than 10 hours. The time difference can be less than a few days, such as less than 1 day, less than 2 days, less than 5 days, or less than 10 days.

Camera and Lighting

In some embodiments, the digitalized representation is an accurate representation of the physical object, for example, performed by digitalized images of the object with high resolution, at every area or portion of the object, or at least, at every area that can characterize the object. The digitalize images can be surface images, for example, images captured by cameras under visible light, infrared light, ultraviolet light, bandpass filtered light, or polarized light. The digitalize images can be sub-surface images, for example, images captured by ultrasound, x-ray, electron beams, or other electromagnetic radiation that can penetrate the surface.

The radiation sensing component, such as one or more cameras having sensors responsive to the desired radiation, can be fixedly positioned with respect to the object. Alternatively, the cameras can be movable with respect to the object, for example, for scanning different areas of the object. Similarly, the object can be fixedly or movably coupled to the cameras.

For example, the cameras can move, relative to the object, in a lateral direction to capture images at different lateral portions of the object. The cameras can move, relative to the object, in an axial direction perpendicular to the lateral direction to capture images at different focus planes, for example, bring different heights of the object into focus. The cameras can rotate, relative to the object, around a lateral direction or a perpendicular direction to capture images at different view points. The different images can be used to uniquely identify the object, such as to capture all aspects of the object, or at least to capture unique characteristics or features of the objects. The different images can be used as an accurate representation of the object.

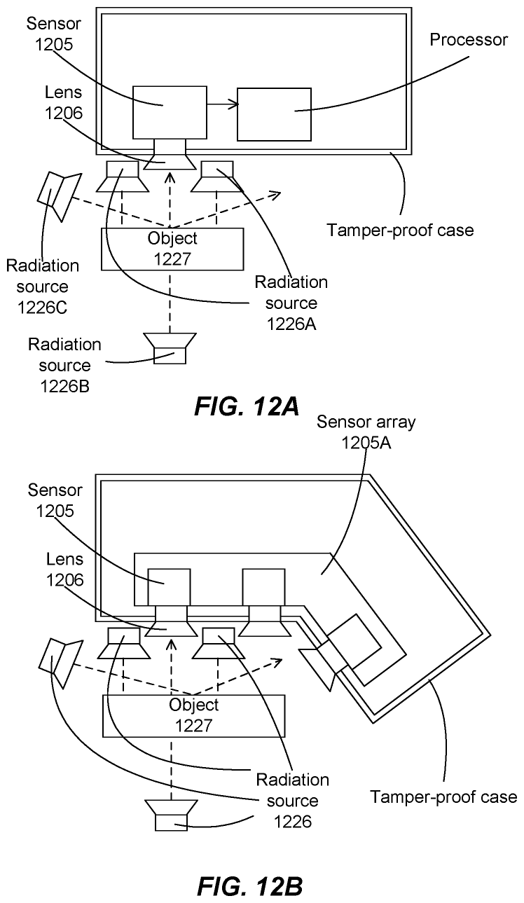

FIGS. 12A-12B illustrate schematic configurations for capturing representations of a physical object according to some embodiments. FIG. 12A shows a configuration for the radiation emitting component. There can be multiple radiation sources, arranged in different orientations relative to the object 1227, such as radiation sources 1226A disposed above the object, radiation sources 1226B disposed under the object, and radiation sources 1226C disposed at sides of the object. Further, there can be one or multiple radiation sources at each orientation.

The different radiation sources can be configured to provide different illumination patterns, e.g., patterns of radiation, for the object. The different illumination patterns can provide a better representation of the object, for example, by allowing the cameras having sensors 1205 and lenses 1206 to capture images under different lighting conditions, which can be used for determine the phase differences of radiation reaching a same area on the object.

FIG. 12B shows a configuration for the radiation sensing component. There can be a camera array 1205A or multiple cameras 1205 with lens 1208, e.g., radiation sensing component, arranged in different orientations relative to the object 1227, such as one or more cameras disposed above the object in a camera array, cameras disposed at sides of the object. Further, there can be cameras at other orientations, such as cameras disposed at a bottom side of the object.

The different cameras can be configured to capture images at different view points for the object. The different view point images can generate a better representation of the object, for example, by providing a more complete view of the object, e.g., viewing the object from different angles. In conjunction with multiple illumination patterns, the set of radiation sources and cameras can generate a digitalized representation of the object that can allow the certification that the digitalized representation is indeed a representation of the object.

In some embodiments, the radiation sensing and emitting components, e.g., the cameras and the radiation sources, are configured to capture data from a physical object, such as a 2D or 3D object, and to process the data into a digitalized representation to establish object uniqueness, e.g., having a tunable confidence level of object uniqueness. The object uniqueness can be used to establish whether or not an object is the same object as when examined previously, or if it is a different object that only appears to be the same to the naked eye.

The captured data can include lateral multiple cameras, multiple illumination patterns, multiple lateral x and y scans, multiple axial scans, and multiple rotational scans. The result of the data capture operation can be a dataset of the form D(micro-camera, illumination pattern, x direction scan, y direction scan, axial scan, rotational scan). In addition, the data capture operation can include object or camera repositioning to have more data in specific manners, such as to fix for blurry or obstructed views of the artifact, or to focus in on specific regions of interest of the artifact.

In some embodiments, the captured data are post processed, for example, by the processor, to ensure that the acquired data is of high enough fidelity for the goal of obtaining the uniqueness of the object, to determine whether there is enough data to confidently assert the uniqueness of the object, or if more data must be acquired.

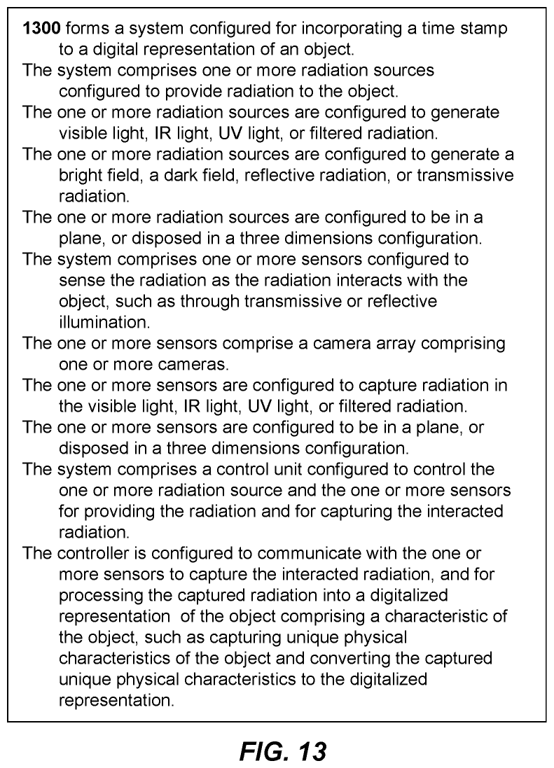

FIG. 13 illustrates a flow chart for forming systems for capturing representations of a physical object according to some embodiments. Operation 1300 forms a system configured for incorporating a time stamp to a digital representation of an object. The system comprises one or more radiation sources configured to provide radiation to the object. The one or more radiation sources are configured to generate visible light, IR light, UV light, or filtered radiation. The one or more radiation sources are configured to generate a bright field, a dark field, reflective radiation, or transmissive radiation. The one or more radiation sources are configured to be in a plane, or disposed in a three dimensions configuration.

The system comprises one or more sensors configured to sense the radiation as the radiation interacts with the object, such as through transmissive or reflective illumination. The one or more sensors comprise a camera array comprising one or more cameras. The one or more sensors are configured to capture radiation in the visible light, IR light, UV light, or filtered radiation. The one or more sensors are configured to be in a plane, or disposed in a three dimensions configuration.

The system comprises a control unit configured to control the one or more radiation source and the one or more sensors for providing the radiation and for capturing the interacted radiation. The controller is configured to communicate with the one or more sensors to capture the interacted radiation, and for processing the captured radiation into a digitalized representation of the object comprising a characteristic of the object, such as capturing unique physical characteristics of the object and converting the captured unique physical characteristics to the digitalized representation.

Tamper Proof

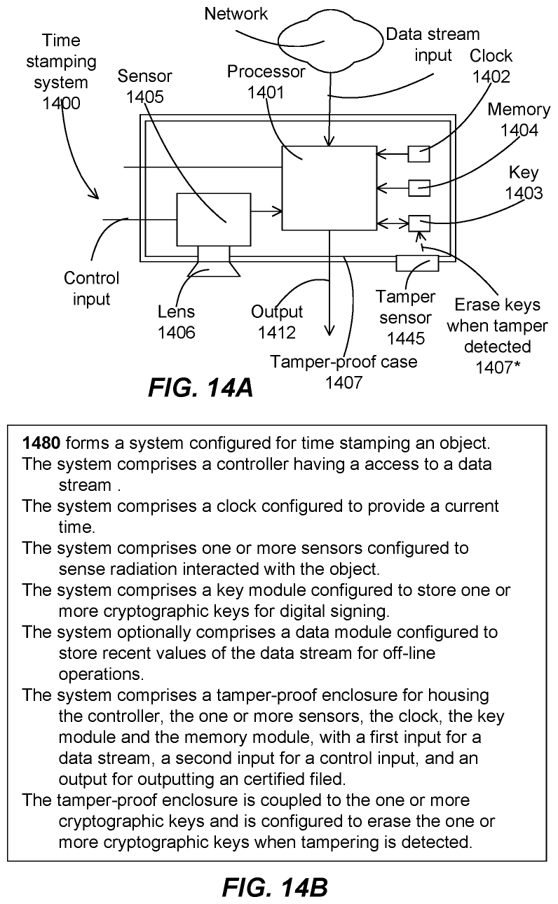

FIGS. 14A-14B illustrate a schematic for a tamper-proof environment for a system configured to time stamping a physical object according to some embodiments. In FIG. 14A, a time stamping system 1400 can have a processor 1401, a clock 1402, one or more cryptographical keys 1403, and an optional memory 1404, together with the sensor 1405 enclosed in a tamper-proof enclosure 1407.

In some embodiments, the tamper-proof configuration can include connecting the sensor and the processor in an impenetrable way. For example, the tamper-proof enclosure surrounding the sensitive components can offer protection against tampering.

The tamper-proof enclosure can have windows to allow the interacted radiation to reach the sensor, where lenses 1404 can be mounted. The tamper-proof enclosure can be equipped with one or more sensors 1445 to detect a tampering action, such as an accelerometer to detect a shock to the enclosure, a pressure sensor in the enclosure to detect an air leak, such as a hole through the enclosure by drilling, or a surface sensor to detect a surface deform, such as a dent to the enclosure.

When a tampering action is detected, the tamper-proof enclosure can be configured to erase the cryptographical keys 1403. Alternatively, or additionally, the tamper-proof enclosure can be configured to erase the program in the processor 1401. Thus, after detecting a tampering action on the tamper-proof enclosure, the system is not capable of perform any further work on generating a time stamped document, e.g., the entire system is unable to certify any subsequent digitization.

In some embodiments, a secure connection between the sensor and the processor can be achieved with a tamper-proof printed circuit board, with the sensor array soldered directly onto one side of the printed circuit board, and the processor soldered on the opposite side of the board. Similar to the tamper-proof enclosure covering the sensor and the processor, the tamper-proof printed circuit board can ensure that data cannot bypass the sensor and be fed directly to the processor, which in turn guarantees that any data that is output from the sensor will have been genuinely scanned and thus necessarily have been physically present.

In FIG. 14B, operation 1480 forms a system configured for time stamping an object. The system comprises a controller having an access to a data stream. The system comprises a clock configured to provide a current time. The system comprises one or more sensors configured to sense radiation interacted with the object. The system comprises a key module configured to store one or more cryptographic keys for digital signing. The system optionally comprises a data module configured to store recent values of the data stream for off-line operations. The system comprises a tamper-proof enclosure for housing the controller, the one or more sensors, the clock, the key module and the memory module, with a first input for a data stream, a second input for a control input, and an output for outputting a certified filed. The tamper-proof enclosure is coupled to the one or more cryptographic keys and is configured to erase the one or more cryptographic keys when tampering is detected.

Alternatively, a system configured for time stamping an object can be formed using a tamper-proof printed circuit board with at least the sensor and the processor soldered directly on the board, such as the sensor soldered in one side and the processor soldered in an opposite side of the board.

Owner Data

In some embodiments, a user-input component is included in the system to identify the claimant, e.g., who currently possesses of the object being imaged. This input must also be contained within the tamper-proof casing, and can include biometric measurements or a keypad to manually type a personal code. Using the user input capability; the digitization can be certified as having had both the owner and the object physically present at the time of scanning.

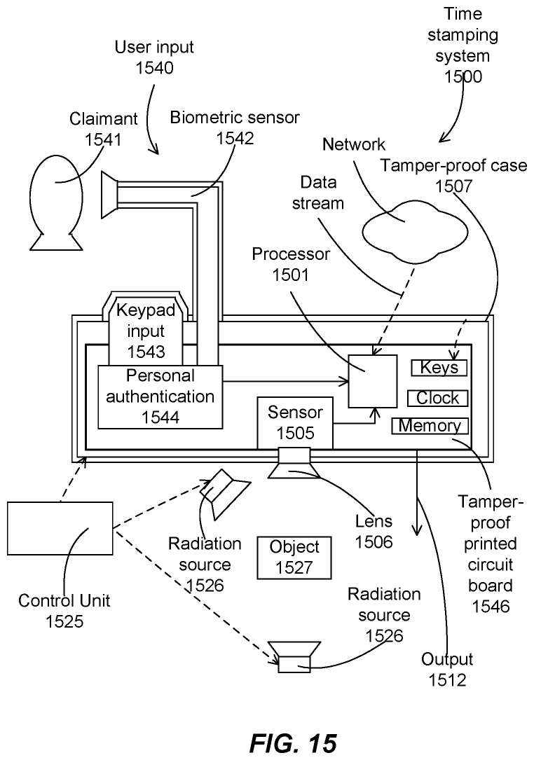

FIG. 15 illustrates a schematic configuration for a system configured to time stamping a physical object with owner data according to some embodiments. A time stamping system 1500 can include a user input unit 1540 for obtaining personal information from a claimant 1541. The user inputs can include a biometric sensor 1542 such as a retina sensor, and a keypad input 1543 for password input, for example. Other inputs can be included, such as fingerprint.

The time stamping system 1500 can include a personal authentication module 1544, which can process the user inputs to generate a user representation, which can be used to identify the claimant 1541. The personal authentication module can be connected to a processor 1501, for example to be combined with a time stamp and a digitalized representation of an object 1527.

In some embodiments, the personal authentication module 1544, the processor 1501, and the sensor 1505 can be soldered on a tamper-proof printed circuit board 1546 for have secure connections between the elements.

The time stamping system 1500 can include a radiation emitting component, such as one or more radiation sources 1526. The time stamping system 1500 can further include a radiation sensing component, such as one or more sensors or sensor arrays 1505. Each sensor or sensor array can include a lens 1506, for focusing or for magnification.

The time stamping system 1500 can further include a processing component, such as a processor 1501, with access to a data stream, such as a sequence of block header hashes 1522. The processor can be configured, e.g., programmed, to obtain one or more block header hashes (or block hashes) from the sequence of block header hashes, through the input connection 1510. For example, the processor can be configured to obtain one block header hash from the block header hash sequence, with the block header hash functioned as a time stamp.

In some embodiments, the system can have a clock, such as an internal clock in the processor, or an external clock for keeping track of the time, such as to time stamp a document with the current time provided by the clock. The system can have a small number of secret keys, which can be used to digitally sign and thereby certify the created file outputs, or can be used to encrypt the signed file. The system can have a memory for storing secret keys, and other data, such as the block header hashes.

In some embodiments, the system can have an output 1512, which is configured to output the time stamped datafile. The output 1512 can be a data transfer cable.

In some embodiments, the system can be configured to be protected from being tampered, such as to prevent attempts to modify the connection between the sensor and the processor. For example, the sensor and the processor can be soldered on a tamper proof printed circuit board 1546, with the tamper-proof board configured to protect the data connection in an impenetrable way.

In some embodiments, the system can be encased in a tamper-proof enclosure 1507, e.g., the critical component of the processor and the sensor with the inputs and output can be housed in the tamper-proof environment, which is to prevent tampering.

In some embodiments, the system can include a control unit 1525, such as a computer or a controller running a program to organize the operation of the individual components.

In operation, after the control unit is triggered, the processor notes the time and creates a start token, such as getting a block header hash from a blockchain. The control unit can signal a claimant to enter personal information, such as through the biometric sensor and through the keypad. The personal authentication module then process the user input data to generate a user representation, which can be sent to the processor.

The control unit can control the radiation emitting component to provide radiation to the object in a specific manner, such as to generate one or more illumination patterns to the object. The control unit then can control the radiation sensing component to sense the radiation as it interacts with the object. The processor processes the interacted radiation to generate a digital representation of the object.

The processor can optionally verify the token, such as verify that the value getting from the data stream earlier has not changed. The verification process can improve the immutability of the token, especially if the token is formed from a most recent block header hash in the blockchain.

Alternatively, the user input can be performed after the generation of the digital representation of the object.

The processor then combines the start token, the digital representation of the physical object, and the user representation into a datafile. The processor then digitally signs and encrypts the datafile. The processor then transmits the signed and encrypted datafile through the output stream. The output datafile can be used for further processing, for example for use in relation to non-fungible token minting or creation.

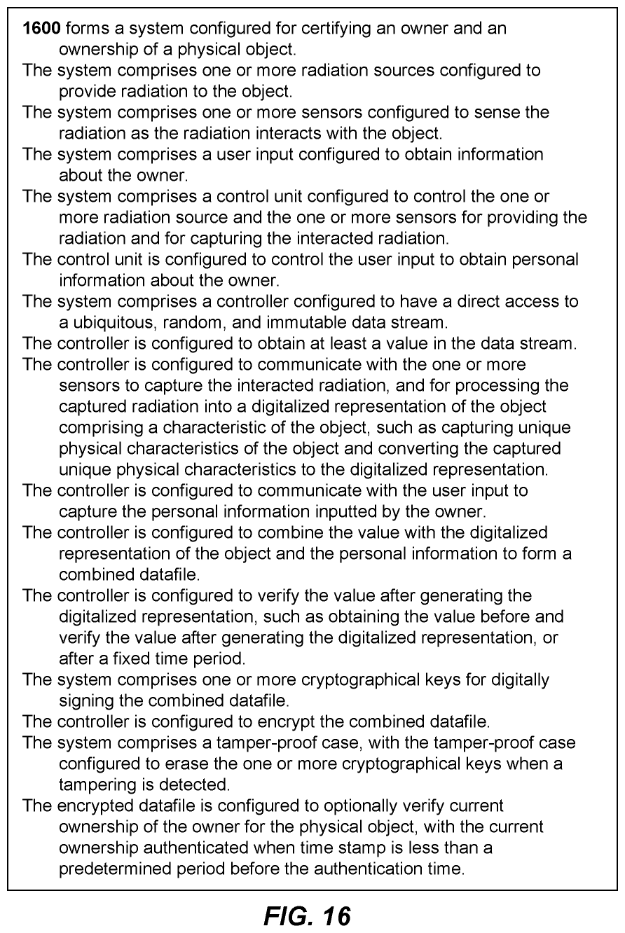

FIG. 16 illustrates a flow chart for forming systems for time stamping a physical object with owner data according to some embodiments. Operation 1600 forms a system configured for certifying an owner and an ownership of a physical object. The system comprises one or more radiation sources configured to provide radiation to the object. The system comprises one or more sensors configured to sense the radiation as the radiation interacts with the object. The system comprises a user input configured to obtain information about the owner. The system comprises a control unit configured to control the one or more radiation source and the one or more sensors for providing the radiation and for capturing the interacted radiation. The control unit is configured to control the user input to obtain personal information about the owner.

The system comprises a controller configured to have a direct access to a ubiquitous, random, and immutable data stream. The controller is configured to obtain at least a value in the data stream. The controller is configured to communicate with the one or more sensors to capture the interacted radiation, and for processing the captured radiation into a digitalized representation of the object comprising a characteristic of the object, such as capturing unique physical characteristics of the object and converting the captured unique physical characteristics to the digitalized representation.

The controller is configured to communicate with the user input to capture the personal information inputted by the owner. The controller is configured to combine the value with the digitalized representation of the object and the personal information to form a combined datafile. The controller is configured to verify the value after generating the digitalized representation, such as obtaining the value before and verify the value after generating the digitalized representation, or after a fixed time period. The system comprises one or more cryptographical keys for digitally signing the combined datafile. The controller is configured to encrypt the combined datafile.

The system comprises a tamper-proof case, with the tamper-proof case configured to erase the one or more cryptographical keys when a tampering is detected. The encrypted datafile is configured to optionally verify current ownership of the owner for the physical object, with the current ownership authenticated when time stamp is less than a predetermined period before the authentication time.

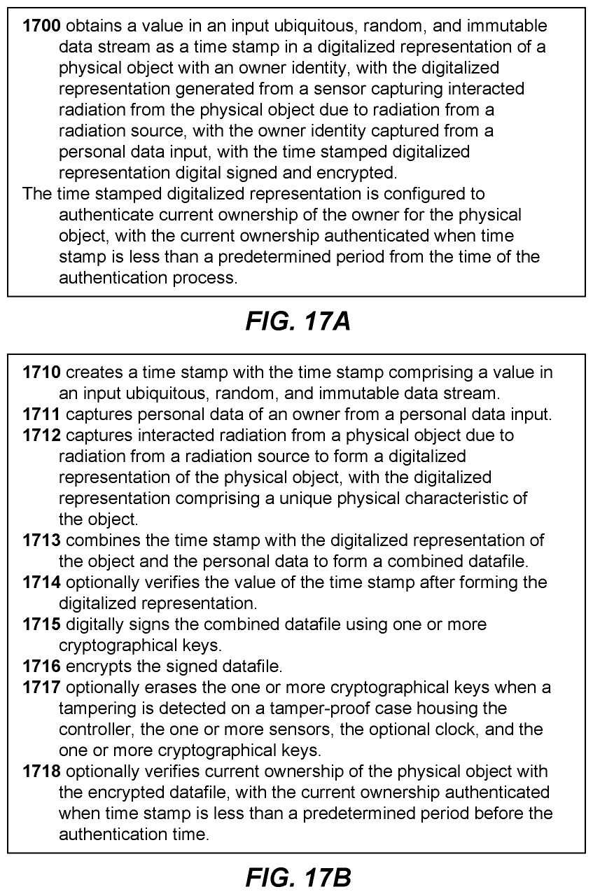

FIGS. 17A-17B illustrate flow charts for time stamping a physical object with owner data according to some embodiments. In FIG. 17A, operation 1700 obtains a value in an input ubiquitous, random, and immutable data stream as a time stamp in a digitalized representation of a physical object with an owner identity, with the digitalized representation generated from a sensor capturing interacted radiation from the physical object due to radiation from a radiation source, with the owner identity captured from a personal data input, with the time stamped digitalized representation digital signed and encrypted. The time stamped digitalized representation is configured to authenticate current ownership of the owner for the physical object, with the current ownership authenticated when time stamp is less than a predetermined period from the time of the authentication process.

In FIG. 17B, operation 1710 creates a time stamp with the time stamp comprising a value in an input ubiquitous, random, and immutable data stream. Operation 1711 captures personal data of an owner from a personal data input. Operation 1712 captures interacted radiation from a physical object due to radiation from a radiation source to form a digitalized representation of the physical object, with the digitalized representation comprising a unique physical characteristic of the object. Operation 1713 combines the time stamp with the digitalized representation of the object and the personal data to form a combined datafile. Operation 1714 optionally verifies the value of the time stamp after forming the digitalized representation. Operation 1715 digitally signs the combined datafile using one or more cryptographical keys. Operation 1716 encrypts the signed datafile. Operation 1717 optionally erases the one or more cryptographical keys when a tampering is detected on a tamper-proof case housing the controller, the one or more sensors, the optional clock, and the one or more cryptographical keys. Operation 1718 optionally verifies current ownership of the physical object with the encrypted datafile, with the current ownership authenticated when time stamp is less than a predetermined period before the authentication time.

Portable System

In some embodiments, a system can be used to perform the time stamp operation on a digitalized representation of a physical object. The time stamp operation relies on a ubiquitous data stream, such as a blockchain. The blockchain is configured in a distributed ledger configuration, which can be duplicated in various servers around the world. Thus, the time stamp operation can need access to a blockchain through a network such as the Internet.

In some embodiments, a portable system, e.g., a system without network connectivity, can be used to perform the time stamp operation. Data from the blockchain can be downloaded to a memory of the portable system, with the memory constantly updated whenever the portable system can be connected to the network.

The portable can use a block from the blockchain that is earlier than a maximum network separation time, to ensure that the time stamp is still the same at the end of the time the portable is separated from the network. For example, the portable can be in the field in the daytime, such as from 8 AM to 8 PM, and will return to base at night, such as from 8 PM to 8 AM of the next day. The portable system can have access to the network at the base, and do not have access to the network in the field. As such, the time stamp can be selected to be longer than 12 hours, such as 15, 20 or 24 hours.

In operation, at the base, the portable system downloads the block header hashes of a blockchain, from the most recent block to the block at 24 hours earlier. The downloading can continue, for example, at every hour or at every 30 minutes. Thus, at 8 AM, when the portable leaves the base, the memory can contain block header hashes for blocks from 7 AM back to 7 AM of the previous day. The portable system can perform time stamping process, with the block header hash for the time stamp token taken earlier, such as at 20 hours earlier.

At 9 AM, the portable system can perform the first time stamping operation. The block header hash for the 9 AM time stamp is taken from the block at 1 PM the previous day, e.g., 20 hours earlier, which is stored in the memory. The portable system can continue to perform the time stamping operation. At 7 PM, the block header hash for the 7 PM time stamp is taken from the block at 11 PM the previous day, which is also stored in the memory. The download period can be configured to allow extra working time. For example, if the portable system is still working at 11 PM, the block header hash for the 11 PM time stamp is taken from the block at 3 AM the same day, which is also stored in the memory.

After the portable system returns to the base, the downloading process continues, to update the memory with the new block header hashes.

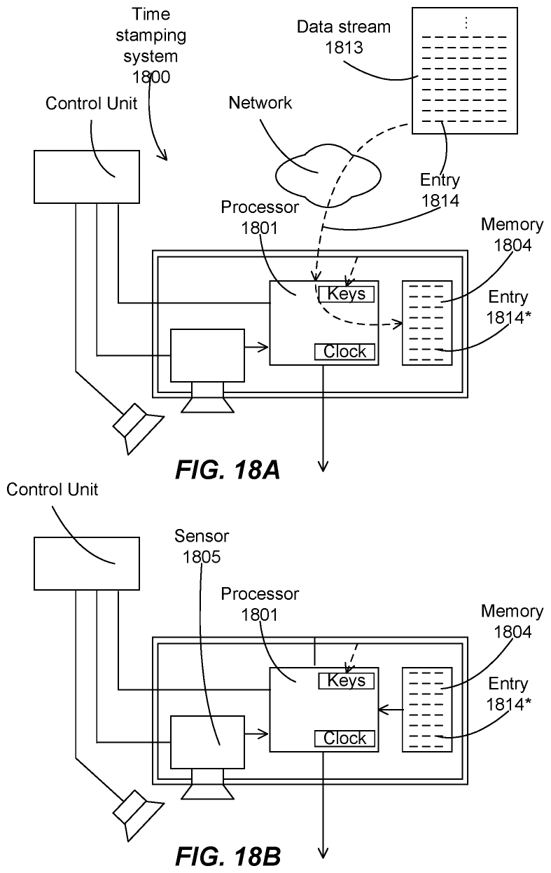

FIGS. 18A-18B illustrate a schematic configuration and flow for an off-line system configured to time stamping a physical object according to some embodiments. In FIG. 18A, a time stamping system 1800 is configured to download entries 1814 from a data stream 1813, such as block header hashes from a sequence of block header hashes. The downloaded entries 1814* are stored in a memory 1804 of the time stamping system 1800. The memory 1804 can be accessed by the processor 1801, for example, to obtain entries 1814* for generating time stamp token.

In FIG. 18B, a time stamping system 1800 is configured to operate in an off-line mode, e.g., without access to the network. The processor 1801 can obtain an entry 1814* from the memory 1804 to form a time stamp token. The sensor 1805 can capture interacted radiation from an object, caused by radiation generated by a radiation source. The capture interacted radiation can be sent to the processor to be processed into a digitalized representation of the object. The processor can combine the time stamp token with the digitalized representation to form a combined datafile. The combined datafile can be signed and encrypted before being sent out.

Since the time stamp token uses an entry, e.g., a block header hash, from the memory, the time stamping system 1800 can operate without a connection to the network. The memory can be updated with new entries when the system has access to the network.

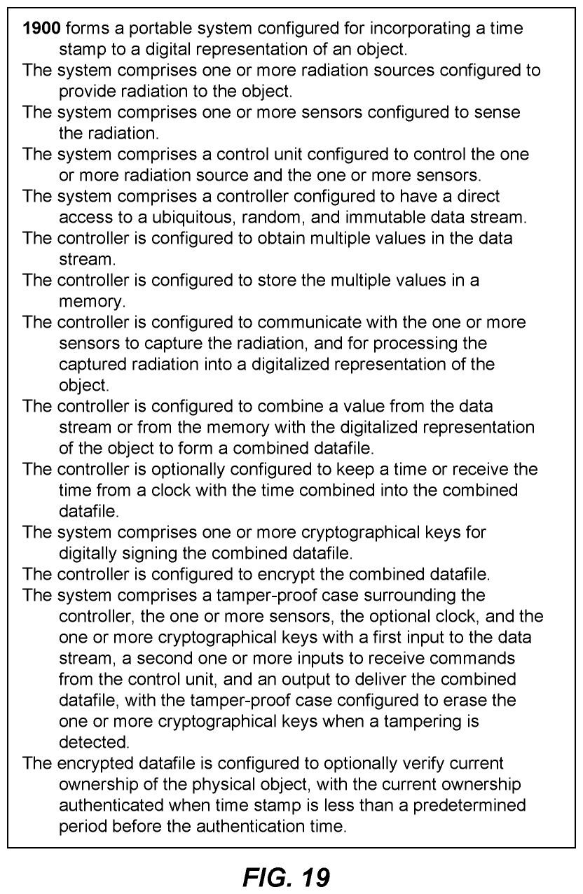

FIG. 19 illustrates a flow chart for forming systems for off-line time stamping a physical object according to some embodiments. Operation 1900 forms a portable system configured for incorporating a time stamp to a digital representation of an object. The system comprises one or more radiation sources configured to provide radiation to the object. The system comprises one or more sensors configured to sense the radiation. The system comprises a control unit configured to control the one or more radiation source and the one or more sensors. The system comprises a controller configured to have a direct access to a ubiquitous, random, and immutable data stream.

The controller is configured to obtain multiple values in the data stream. The controller is configured to store the multiple values in a memory. The controller is configured to communicate with the one or more sensors to capture the radiation, and for processing the captured radiation into a digitalized representation of the object. The controller is configured to combine a value from the data stream or from the memory with the digitalized representation of the object to form a combined datafile. The controller is optionally configured to keep a time or receive the time from a clock with the time combined into the combined datafile.

The system comprises one or more cryptographical keys for digitally signing the combined datafile. The controller is configured to encrypt the combined datafile. The system comprises a tamper-proof case surrounding the controller, the one or more sensors, the optional clock, and the one or more cryptographical keys with a first input to the data stream, a second one or more inputs to receive commands from the control unit, and an output to deliver the combined datafile, with the tamper-proof case configured to erase the one or more cryptographical keys when a tampering is detected.

The encrypted datafile is configured to optionally verify current ownership of the physical object, with the current ownership authenticated when time stamp is less than a predetermined period before the authentication time.

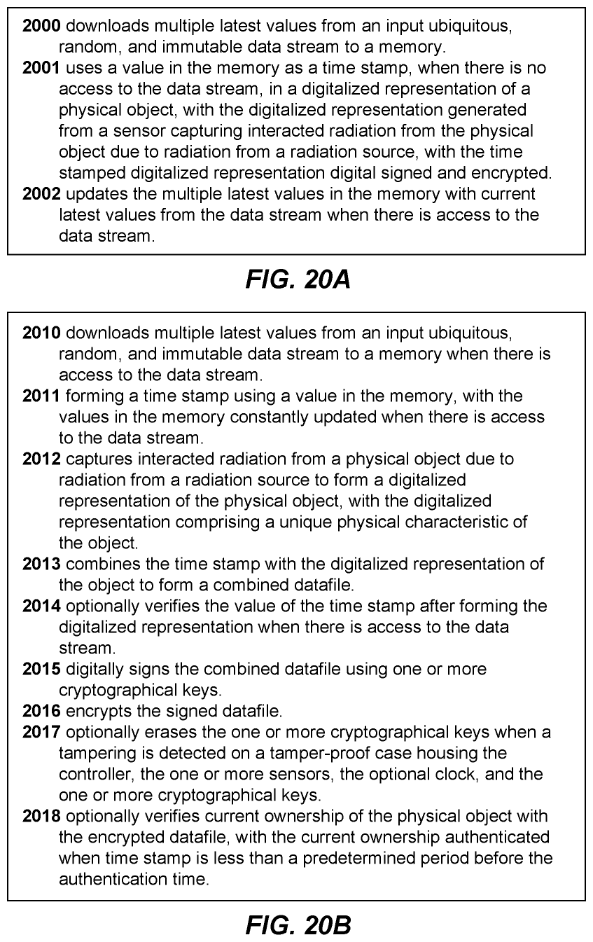

FIGS. 20A-20B illustrate flow charts for off-line time stamping a physical object according to some embodiments. In FIG. 20A, operation 2000 downloads multiple latest values from an input ubiquitous, random, and immutable data stream to a memory. Operation 2001 uses a value in the memory as a time stamp, when there is no access to the data stream, in a digitalized representation of a physical object, with the digitalized representation generated from a sensor capturing interacted radiation from the physical object due to radiation from a radiation source, with the time stamped digitalized representation digital signed and encrypted. Operation 2002 updates the multiple latest values in the memory with current latest values from the data stream when there is access to the data stream.

In FIG. 20B, operation 2010 downloads multiple latest values from an input ubiquitous, random, and immutable data stream to a memory when there is access to the data stream. Operation 2011 forming a time stamp using a value in the memory, with the values in the memory constantly updated when there is access to the data stream. Operation 2012 captures interacted radiation from a physical object due to radiation from a radiation source to form a digitalized representation of the physical object, with the digitalized representation comprising a unique physical characteristic of the object. Operation 2013 combines the time stamp with the digitalized representation of the object to form a combined datafile. Operation 2014 optionally verifies the value of the time stamp after forming the digitalized representation when there is access to the data stream. Operation 2015 digitally signs the combined datafile using one or more cryptographical keys. Operation 2016 encrypts the signed datafile. Operation 2017 optionally erases the one or more cryptographical keys when a tampering is detected on a tamper-proof case housing the controller, the one or more sensors, the optional clock, and the one or more cryptographical keys.

Operation 2018 optionally verifies current ownership of the physical object with the encrypted datafile, with the current ownership authenticated when time stamp is less than a predetermined period before the authentication time.

In some embodiments, the reference numbers are classified with the last 2 digits referring to a same component or element, and the first one or 2 digits referring to the number of the figures. For example, 101, 601, 701, 801, 1401, 1501, and 1801 all refer to a processor, e.g., the last 2 digits of 01 refer to a processor, while the first one or two digits of 1, 6, 7, 8, 14, 15, and 18 refer to the figure numbers. There can be exception, for example, in the flow chart number for the steps.

What is claimed is:

1. A method to incorporate a time stamp to a digital representation of a physical object, the method comprising
obtaining a data string from a ubiquitous data stream comprising recently randomly generated immutable data;
creating a time stamp comprising the data string;
capturing interacted radiation from the physical object due to radiation from one or more radiation sources to form the digitalized representation of the physical object,
combining the time stamp with the digitalized representation to form a datafile.

2. A method as in claim 1,
wherein the ubiquitous data stream is synchronized ubiquitously throughout the world,
wherein the randomly generated data is practically impossible to predict in advance,
wherein the immutable data is practically unchageable after a time period of more than one minute.

3. A method as in claim 1, further comprising
generating a hash of the combined datafile;
encrypting the hash with a first key cryptographical key;
encrypting the combined datafile and the encrypted hash with a second cryptographical key.

4. A method as in claim 1, further comprising
verifying current ownership of the physical object with the encrypted datafile, with the current ownership verified when the time stamp is less than a predetermined period before the current time.

5. A method to certify current ownership of a physical object, the method comprising
obtaining a block header hash, with the block header hash generated from a block header of a block of a blockchain;
creating a time stamp comprising the block header hash;
capturing interacted radiation from the physical object due to radiation from one or more radiation sources to form the digitalized representation of the physical object,
combining the time stamp with the digitalized representation to form a datafile;
digitally signing the datafile using a first cryptographical key;
encrypting the signed datafile using a second cryptographical key to generate a certified datafile,
wherein the first cryptographical key is the same or different from the second cryptographical key,
wherein the certified datafile is configured to verify current ownership of the physical object when the time stamp is less than a predetermined period before the current time.

6. A method as in claim 5,
wherein an average time between blocks of the blockchain is less than 1 minute.

7. A method as in claim 5,
wherein the block is a latest confirmed block of the blockchain at a time of obtaining the block.

8. A method as in claim 5,
wherein the block is separated from a latest block of the blockchain by a predetermined number of blocks at a time of obtaining the block.

9. A method as in claim 5,
wherein the block is separated from a latest block of the blockchain by a predetermined period of time from a time of obtaining the block.

10. A method as in claim 5,
wherein the block is a latest block of the blockchain at a time of obtaining the block,
the method further comprising
verifying that the data string does not changed after forming the digitalized representation or after a fixed time period.

11. A method as in claim 5,
wherein forming the digitalized representation of the physical object comprises processing the captured interactive radiation into the digitalized representation,
wherein processing the captured interactive radiation comprises probing unique physical characteristics of the physical object and converting the characteristics to a digitized format.

12. A method as in claim 5, further comprising
transmitting the combined datafile to use in a non-fungible token minting or creation.

13. A method as in claim 5, further comprising
erasing at least the first cryptographical key when a tampering action is detected on a housing for a sensor configured to capture the interacted radiation and a processor configured to form the digitalized representation of the physical object or on a connection between the sensor and the processor.

14. A method as in claim 5, further comprising
obtaining a user input for identifying an owner of the physical object, with the user input combined with the combined datafile,
wherein the combined datafile is configured to verify the owner and current ownership of the owner of the physical object.

15. A method as in claim 5, further comprising
downloading multiple block header hashes from a sequence of block header hashes of a blockchain using a link to a network to a memory when there is a connection to the network,
using a block header hash from the multiple block header hashes in the memory in place of the block header hash from the network when there is no connection to the network.

16. A system to certify ownership of a physical object, the system comprising
one or more radiation sources configured to generate radiation to the physical object;
one or more sensors configured to capture interacted radiation from the physical object due to the radiation from the one or more radiation sources;
a processor comprising an access to a data stream, with the data stream comprising a list of block header hashes with each block header hash generated from a block header of a block of a blockchain,
wherein the processor is configured to create a time stamp comprising a block header hash of the list of block header hashes,
wherein the processor is configured to capture the interacted radiation,
wherein the processor is configured to form a digitalized representation of the physical object from the captured interacted radiation,
wherein the processor is configured to combine the time stamp with the digitalized representation to form a datafile,
wherein the processor is configured to digitally sign the datafile using a first cryptographical key,
wherein the processor is configured to encrypt the signed datafile using a second cryptographical key to generate a certified datafile,
wherein the first cryptographical key is the same or different from the second cryptographical key,
wherein the certified datafile is configured to verify current ownership of the physical object when the time stamp is less than a predetermined period before the current time;
a housing surrounding the one or more sensors, the processor, and at least the first cryptographical key,
wherein the housing is coupled to the at least the first cryptographical key and is configured to erase the at least the first cryptographical key when a tampering action on the housing is detected.

17. A system as in claim 16,
wherein the radiation from the one or more radiation sources comprises visible light, infrared light, ultraviolet light, x-ray, filtered light, ultrasound, electron beams. radiation passing through filters coupled to the one or more radiation sources, or radiation configured to generate a reflective radiation of a light field or a dark field, or a transmissive radiation,
wherein the one or more sensors comprise high-resolution cameras, a camera array, an optical or electron microscope, or an x-ray machine.

18. A system as in claim 16, further comprising
a printed circuit board,
wherein the one or more sensors soldered on one side of the printed circuit board and the processor soldered on an opposite side,
wherein the printed circuit board is configured to prevent tampering of connection lines between the one or more sensors and the processor.

19. A system as in claim 16, further comprising
a user input unit for obtaining personal information from a person, with the personal information processed before being combined with the datafile.

20. A system as in claim 16, further comprising
a memory coupled to the processor,
wherein the memory is configured to store multiple block header hashes downloaded from the data stream using a link to a network when there is a connection to the network,
wherein the processor is configured to use a block header hash from the multiple block header hashes in the memory in place of the block header hash from the data stream when there is no connection to the network.
